(19) United States
(12) Patent Application Publication
(10) Pub. No.: US 2026/0222109 A1
(43) Pub. Date: Jul. 30, 2026

(54) Information Sending Method, Information Receiving Method, and Related Apparatus

(71) Applicant: HUAWEI TECHNOLOGIES CO., LTD., Shenzhen (CN)

(72) Inventors: Kangjian Qin, Hangzhou (CN); Huazi Zhang, Hangzhou (CN); Jiajie Tong, Hangzhou (CN); Xianbin Wang, Hangzhou (CN); Ke Liu, Hangzhou (CN); Jun Wang, Hangzhou (CN); Yinggang Du, Shenzhen (CN)

(73) Assignee: HUAWEI TECHNOLOGIES CO., LTD., Shenzhen (CN)

(21) Appl. No.: 19/573,716

(22) Filed: Mar. 20, 2026

Related U.S. Application Data
(63) Continuation of application No. PCT/CN2023/120807, filed on Sep. 22, 2023.

(51) Int. Cl. H04L 1/00

(52) U.S. Cl. CPC H04L 1/0043; H04L 1/0057; H04L 1/0075

(57) ABSTRACT

An information sending method, an information receiving method, and a related apparatus enable a first communication apparatus to send 1^{st}-stage information and 2^{nd}-stage information, where the 2^{nd}-stage information is generated based on an encoding scheme and/or a segmentation scheme determined according to a first rule. In this way, the 2^{nd}-stage information is transmitted. A first communication apparatus determines the 1^{st}-stage information and the 2^{nd}-stage information that correspond to a same service type, where the 1^{st}-stage information is transmitted on a control channel and/or a shared channel, the 2^{nd}-stage information is transmitted on the shared channel, the 2^{nd}-stage information is generated based on the encoding scheme and/or the segmentation scheme determined according to the first rule.

### CROSS-REFERENCE TO RELATED APPLICATION

This is a continuation of International Patent Application No. PCT/CN2023/120807 filed on Sep. 22, 2023, which is hereby incorporated by reference in its entirety.

### TECHNICAL FIELD

This relates to the field of communication technologies, and in particular, to an information sending method, an information receiving method, and a related apparatus.

### BACKGROUND

To support new emerging service scenarios such as extended reality (XR), integrated sensing and communication, and artificial intelligence for network (AI-for-Net) in future communication, a large amount of non-conventional communication information may be generated in the future. Such information may have a length similar to that of conventional communication information transmitted on a physical uplink shared channel (PUSCH) or a physical downlink shared channel (PDSCH), but may be transmitted only at a layer 1 (L1) and not reported to a higher layer along with the conventional communication information.

Therefore, how to design a transmission manner for such non-conventional communication information urgently needs to be explored by researchers.

### SUMMARY

This disclosure provides an information sending method, an information receiving method, and a related apparatus for a first communication apparatus to send 1^{st}-stage information and 2^{nd}-stage information, to transmit the 2^{nd}-stage information. The 2^{nd}-stage information is generated based on an encoding scheme and/or a segmentation scheme that are/is determined according to a first rule. In this way, an appropriate encoding scheme and/or segmentation scheme are/is selected for the 2^{nd}-stage information, to help improve encoding performance of the 2^{nd}-stage information, so that a transmission manner of the 2^{nd}-stage information can adapt to different service scenarios of non-conventional communication information, thereby flexibly sending the 2^{nd}-stage information.

A first aspect of this disclosure provides an information sending method. The method may be performed by a first communication apparatus. The first communication apparatus may be a terminal device or a network device, or a component (for example, a processor, a chip, or a chip system) in a terminal device or a network device, or a logic module or software that can implement all or a part of functions of a terminal device, or a logic module or software that can implement all or a part of functions of a network device. The method includes:

The first communication apparatus determines 1^{st}-stage information and 2^{nd}-stage information that correspond to a same service type, where the 1^{st}-stage information is transmitted on a control channel and/or a shared channel, the 2^{nd}-stage information is transmitted on the shared channel, the 2^{nd}-stage information is generated based on an encoding scheme and/or a segmentation scheme determined according to a first rule, and the 1^{st}-stage information is for decoding the 2^{nd}-stage information; and the first communication apparatus outputs the 1^{st}-stage information and the 2^{nd}-stage information.

It can be learned from the technical solution that the first communication apparatus outputs the 1^{st}-stage information and the 2^{nd}-stage information corresponding to the same service type, and the 2^{nd}-stage information is generated based on the encoding scheme and/or the segmentation scheme determined according to the first rule. In this way, the 2^{nd}-stage information is transmitted. Further, the first communication apparatus determines the encoding scheme and/or the segmentation scheme of the 2^{nd}-stage information according to the first rule. In this way, the first communication apparatus segments the 2^{nd}-stage information based on the segmentation scheme, and then encodes segmented 2^{nd}-stage information based on the encoding scheme. In this way, the first communication apparatus selects an appropriate encoding scheme and segmentation scheme based on a situation of the 2^{nd}-stage information. This helps improve encoding performance of the 2^{nd}-stage information, and compensates for not supporting segmenting the 2^{nd}-stage information in a current communication protocol. The transmission manner of the 2^{nd}-stage information can adapt to different service scenarios of non-conventional communication information, thereby flexibly sending the 2^{nd}-stage information.

According to the first aspect, in a possible implementation, the first rule includes: segmenting the 2^{nd}-stage information based on a first length, and encoding segmented 2^{nd}-stage information based on a polar code encoding scheme, where the first length is 2ⁿ, and n is a positive integer. In this implementation, the first communication apparatus segments the 2^{nd}-stage information based on the first length by default, and encodes the 2^{nd}-stage information based on the polar code encoding scheme by default. In this way, the 2^{nd}-stage information is segmented and encoded, to improve encoding performance. There is no need to indicate the encoding scheme and the segmentation scheme via instruction signaling, thereby reducing signaling overheads.

According to the first aspect, in a possible implementation, the first length is less than 1024. In this implementation, the first length is less than a maximum encoding length supported by the polar code encoding scheme. This facilitates the first communication apparatus to encode the segmented 2^{nd}-stage information based on the polar code encoding scheme.

According to the first aspect, in a possible implementation, the first length is 32, 64, 128, 256, or 512.

According to the first aspect, in a possible implementation, the first rule includes: segmenting the 2^{nd}-stage information based on a second length, and encoding segmented 2^{nd}-stage information based on a low-density parity-check code (LDPC) encoding scheme. In this implementation, the first communication apparatus segments the 2^{nd}-stage information based on the second length by default, and encodes the 2^{nd}-stage information based on the LDPC encoding scheme by default. In this way, the 2^{nd}-stage information is segmented and encoded, to improve encoding performance. There is no need to indicate the encoding scheme and the segmentation scheme via instruction signaling, thereby reducing signaling overheads.

According to the first aspect, in a possible implementation, the second length is determined based on a payload size and a channel coding rate of the 2^{nd}-stage information. In this way, an appropriate segment length is selected based on an actual situation of the 2^{nd}-stage information. This helps improve encoding performance.

According to the first aspect, in a possible implementation, in correspondence to the payload size of the 2^{nd}-stage information less than or equal to 292, or in correspondence to the payload size of the 2^{nd}-stage information less than or equal to 3824 and the channel coding rate of the 2^{nd}-stage information less than or equal to 0.25, the 2^{nd}-stage information is segmented based on the second length of 3840, and LDPC encoding is performed on the segmented 2^{nd}-stage information based on a base graph (BG) 2; or in correspondence to the payload size of the 2^{nd}-stage information greater than 292, or in correspondence to the payload size of the 2^{nd}-stage information greater than 3824 and the channel coding rate of the 2^{nd}-stage information greater than 0.25, the 2^{nd}-stage information is segmented based on the second length of 8448, and LDPC encoding is performed on the segmented 2^{nd}-stage information based on a BG 1, where the BG 1 is different from the BG 2. In this implementation, an appropriate segment length and an appropriate encoding scheme are selected based on the payload size and/or the channel coding rate of the 2^{nd}-stage information. For the 2^{nd}-stage information whose payload size is less than or equal to 292, or if the payload size of the 2^{nd}-stage information is less than or equal to 3824 and the channel coding rate of the 2^{nd}-stage information is less than or equal to 0.25, the first communication apparatus performs LDPC encoding on the segmented 2^{nd}-stage information based on the BG 2. The second length is 3840, that is, a maximum length supported by an encoding matrix used in the LDPC encoding scheme based on the BG 2. Otherwise, the first communication apparatus performs LDPC encoding on the segmented 2^{nd}-stage information based on the BG 1. The second length is 8448, that is, a maximum length supported by an encoding matrix used in the LDPC encoding scheme based on the BG 1. This helps improve encoding performance.

According to the first aspect, in a possible implementation, the first rule includes: determining the encoding scheme and/or the segmentation scheme of the 2^{nd}-stage information based on a payload size of the 2^{nd}-stage information and a channel coding rate of the 2^{nd}-stage information. In this implementation, the encoding scheme and/or the segmentation scheme of the 2^{nd}-stage information are/is determined based on the payload size of the 2^{nd}-stage information and the channel coding rate of the 2^{nd}-stage information. This helps improve encoding performance of the 2^{nd}-stage information. There is no need to indicate the encoding scheme and the segmentation scheme via instruction signaling, thereby reducing signaling overheads.

According to the first aspect, in a possible implementation, the first rule includes: in correspondence to the payload size of the 2^{nd}-stage information less than or equal to 384 and the channel coding rate of the 2^{nd}-stage information less than or equal to 0.5, or in correspondence to the payload size of the 2^{nd}-stage information less than or equal to 140, the first communication apparatus encodes the 2^{nd}-stage information based on a polar code encoding scheme without segmentation; or in correspondence to the payload size of the 2^{nd}-stage information greater than 384 and the channel coding rate of the 2^{nd}-stage information greater than 0.5, or in correspondence to the payload size of the 2^{nd}-stage information greater than 140, segments the 2^{nd}-stage information based on a segment length of 3840, and encodes segmented 2^{nd}-stage information based on an LDPC encoding scheme. In this implementation, when the payload size of the 2^{nd}-stage information is small and/or the channel coding rate is small, the first communication apparatus encodes the 2^{nd}-stage information based on the polar code encoding scheme without segmentation. Performance of polar code encoding is good, thereby helping improve encoding performance. Otherwise, when the payload size of the 2^{nd}-stage information is large and/or the channel coding rate is large, the first communication apparatus encodes the segmented 2^{nd}-stage information based on the LDPC encoding scheme. This helps improve encoding performance. The first communication apparatus segments the 2^{nd}-stage information based on the segment length of 3840, and 3840 may be a maximum length supported by an encoding matrix used in the LDPC encoding scheme used by the first communication apparatus. In this way, LDPC encoding is performed on the 2^{nd}-stage information.

According to the first aspect, in a possible implementation, the first rule includes: determining the encoding scheme and/or the segmentation scheme of the 2^{nd}-stage information based on a length of rate-matched 2^{nd}-stage information, a number of available physical resources, and/or a modulation order. In this way, an appropriate encoding scheme and/or segmentation scheme are selected for the 2^{nd}-stage information, to improve encoding performance. There is no need to indicate the encoding scheme and the segmentation scheme via instruction signaling, thereby reducing signaling overheads.

According to the first aspect, in a possible implementation, the first rule includes: in correspondence to the length of the rate-matched 2^{nd}-stage information less than or equal to a maximum length, determining a number of segments of the 2^{nd}-stage information based on a maximum encoding length supported by a polar code encoding scheme and the number of available physical resources, segmenting the 2^{nd}-stage information based on the number of segments of the 2^{nd}-stage information, and encoding segmented 2^{nd}-stage information based on the polar code encoding scheme; or in correspondence to the length of the rate-matched 2^{nd}-stage information greater than the maximum length, determining a number of segments of the 2^{nd}-stage information based on a maximum encoding length supported by an LDPC encoding scheme and the number of available physical resources, segmenting the 2^{nd}-stage information based on the number of segments of the 2^{nd}-stage information, and encoding segmented 2^{nd}-stage information based on the LDPC encoding scheme, where the maximum length is determined based on the number of available resources and the modulation order. It can be learned that, when the length of the rate-matched 2^{nd}-stage information is less than or equal to the maximum length, the first communication apparatus may preferentially select the polar encoding scheme to encode the 2^{nd}-stage information, thereby improving encoding performance. The first communication apparatus determines the number of segments of the 2^{nd}-stage information based on the maximum encoding length supported by the polar code encoding scheme and the number of available physical resources, and then segments the 2^{nd}-stage information based on the number of segments of the 2^{nd}-stage information. In this way, the first communication apparatus performs polar code encoding on the segmented 2^{nd}-stage information. Otherwise, the first communication apparatus preferentially selects the LDPC encoding scheme to encode the 2^{nd}-stage information, to improve encoding performance. The first communication apparatus determines the number of segments of the 2^{nd}-stage information based on the maximum encoding length supported by the LDPC encoding scheme and the number of available physical resources, and segments the 2^{nd}-stage information based on the number of segments of the 2^{nd}-stage information. In this way, the first communication apparatus performs LDPC encoding on the segmented 2^{nd}-stage information.

According to the first aspect, in a possible implementation, the maximum encoding length supported by the polar encoding scheme is 1024.

According to the first aspect, in a possible implementation, the maximum encoding length supported by the LDPC encoding scheme is 3840.

According to the first aspect, in a possible implementation, the number of available physical resources is Eₜₒₜₐₗ; the maximum encoding length supported by the polar encoding scheme or the maximum encoding length supported by the LDPC encoding scheme is represented as Nₘ; and if Eᵣₑₛₜ is less than

$$\frac{9 {N}_{m}}{16} ,$$

the number C of segments=C₁, or if Eᵣₑₛₜ is greater than or equal to

$$\frac{9 {N}_{m}}{16} ,$$

the number C of segments=C₁+1, where Eᵣₑₛₜ=Eₜₒₜₐₗ−C₁×Nₘ, and C₁=[Eₜₒₜₐₗ/Nₘ]. The number of segments of the 2^{nd}-stage information is determined based on the number of available physical resources. When remaining physical resources Eᵣₑₛₜ are less than

$$\frac{9 {N}_{m}}{16} ,$$

the number of segments may be C₁, or otherwise, the number of segments may be C₁+1. This helps improve encoding performance and transmission performance.

According to the first aspect, in a possible implementation, the 1^{st}-stage information includes first indication information, and the first indication information indicates the encoding scheme used for the 2^{nd}-stage information. The encoding scheme used for the 2^{nd}-stage information is indicated in the 1^{st}-stage information, so that no signaling indication is additionally required, and signaling overheads are reduced.

According to the first aspect, in a possible implementation, the first indication information is a first field in the 1^{st}-stage information.

According to the first aspect, in a possible implementation, when a value of the first field is 0, it indicates that the 2^{nd}-stage information is encoded based on the polar code encoding scheme; or when a value of the first field is 1, it indicates that the 2^{nd}-stage information is encoded based on the LDPC encoding scheme. In this way, the encoding scheme of the 2^{nd}-stage information is indicated, to facilitate the first communication apparatus to encode the 2^{nd}-stage information based on an appropriate encoding scheme, thereby improving encoding performance.

According to the first aspect, in a possible implementation, the first rule includes: in correspondence to the first indication information indicating that the polar code encoding scheme is used to encode the 2^{nd}-stage information, encoding the 2^{nd}-stage information without segmentation; or in correspondence to the first indication information indicating that the LDPC encoding scheme is used to encode the 2^{nd}-stage information, segmenting the 2^{nd}-stage information based on a third length. In the implementation, a protocol may specify the segmentation scheme of the 2^{nd}-stage information based on the encoding scheme indicated by the first indication information. This facilitates the first communication apparatus to segment the 2^{nd}-stage information based on an appropriate segmentation scheme, and then encode segmented 2^{nd}-stage information.

According to the first aspect, in a possible implementation, the first rule includes: in correspondence to a modulation order of the 2^{nd}-stage information less than or equal to a first threshold, encoding the 2^{nd}-stage information based on a polar code encoding scheme without segmentation; or in correspondence to a modulation order of the 2^{nd}-stage information greater than the first threshold, segmenting the 2^{nd}-stage information based on a third length, and encoding segmented 2^{nd}-stage information based on an LDPC encoding scheme. When the modulation order is small, a payload length of the 2^{nd}-stage information is usually small, and the first communication apparatus uses the polar code encoding scheme to encode the 2^{nd}-stage information, thereby helping improve encoding performance. When the modulation order is large, a payload length of the 2^{nd}-stage information is usually large, and the first communication apparatus uses the LDPC encoding scheme to encode the 2^{nd}-stage information, so that encoding performance is good.

According to the first aspect, in a possible implementation, the third length is 3840 or 8448. In this implementation, an example of the third length is a maximum length supported by an encoding matrix used when the first communication apparatus uses the LDPC encoding scheme. In this way, compatibility with the current LDPC encoding scheme is implemented.

According to the first aspect, in a possible implementation, the first rule includes: in correspondence to the 2^{nd}-stage information that is first-type information, encoding the 2^{nd}-stage information based on a polar code encoding scheme without segmentation; or in correspondence to the 2^{nd}-stage information that is second-type information or third-type information, segmenting the 2^{nd}-stage information based on a fourth length, and encoding segmented 2^{nd}-stage information based on an LDPC encoding scheme. For the first-type information, a length of the 2^{nd}-stage information is usually small, and the first communication apparatus uses the polar code encoding scheme to encode the 2^{nd}-stage information, thereby helping improve encoding performance. For the second-type information or the third-type information, a payload length of the 2^{nd}-stage information is usually large, and the first communication apparatus uses the LDPC encoding scheme to encode the 2^{nd}-stage information, so that encoding performance is good.

According to the first aspect, in a possible implementation, the first-type information is tera-bit multiple-input multiple-output channel state information (T-MIMO CSI), the second-type information is sensing-related information (sensing information), and the third-type information is artificial intelligence-related information (AI-training information). In this way, several possible application scenarios of this disclosure are shown, and the information of these types may be understood as non-conventional communication information, that is, information transmitted at a layer 1.

According to the first aspect, in a possible implementation, the fourth length is determined based on a payload size and a channel coding rate of the 2^{nd}-stage information. In this way, the segment length is determined based on a parameter of the 2^{nd}-stage information, to facilitate the first communication apparatus to encode the segmented 2^{nd}-stage information.

According to the first aspect, in a possible implementation, in correspondence to the payload size of the 2^{nd}-stage information less than or equal to 292, or in correspondence to the payload size of the 2^{nd}-stage information less than or equal to 3824 and the channel coding rate of the 2^{nd}-stage information less than or equal to 0.25, the 2^{nd}-stage information is segmented based on the fourth length of 3840, and LDPC encoding is performed on the segmented 2^{nd}-stage information based on a BG 2; or in correspondence to the payload size of the 2^{nd}-stage information greater than 292, or in correspondence to the payload size of the 2^{nd}-stage information greater than 3824 and the channel coding rate of the 2^{nd}-stage information greater than 0.25, the 2^{nd}-stage information is segmented based on the fourth length of 8448, and LDPC encoding is performed on the segmented 2^{nd}-stage information based on a BG 1. For the 2^{nd}-stage information whose payload size is less than or equal to 292, or if the payload size of the 2^{nd}-stage information is less than or equal to 3824 and the channel coding rate of the 2^{nd}-stage information is less than or equal to 0.25, the first communication apparatus performs LDPC encoding on the segmented 2^{nd}-stage information based on the BG 2. The fourth length is 3840, that is, a maximum length supported by an encoding matrix used in the LDPC encoding scheme based on the BG 2. Otherwise, the first communication apparatus performs LDPC encoding on the segmented 2^{nd}-stage information based on the BG 1. The fourth length is 8448, that is, a maximum length supported by an encoding matrix used in the LDPC encoding scheme based on the BG 1. This helps improve encoding performance.

According to the first aspect, in a possible implementation, the first rule includes: determining a fifth length based on a payload size and a channel coding rate of the 2^{nd}-stage information; and segmenting the 2^{nd}-stage information based on the fifth length, and encoding segmented 2^{nd}-stage information based on an LDPC encoding scheme. In this implementation, the first communication apparatus determines the segment length based on a parameter of the 2^{nd}-stage information, and encodes the segmented 2^{nd}-stage information based on the segment length. This helps improve encoding performance.

According to the first aspect, in a possible implementation, in correspondence to the payload size of the 2^{nd}-stage information less than or equal to 292, or in correspondence to the payload size of the 2^{nd}-stage information less than or equal to 3824 and the channel coding rate of the 2^{nd}-stage information less than or equal to 0.25, the fifth length is 3840; or in correspondence to the payload size of the 2^{nd}-stage information greater than 292, or in correspondence to the payload size of the 2^{nd}-stage information greater than 3824 and the channel coding rate of the 2^{nd}-stage information greater than 0.25, the fifth length is 8448. In this implementation, for the 2^{nd}-stage information whose payload size is less than or equal to 292, or if the payload size of the 2^{nd}-stage information is less than or equal to 3824 and the channel coding rate of the 2^{nd}-stage information is less than or equal to 0.25, the first communication apparatus performs LDPC encoding on the segmented 2^{nd}-stage information based on the BG 2. The fifth length is 3840, that is, a maximum length supported by an encoding matrix used in the LDPC encoding scheme based on the BG 2. Otherwise, the first communication apparatus performs LDPC encoding on the segmented 2^{nd}-stage information based on the BG 1. The fifth length is 8448, that is, a maximum length supported by an encoding matrix used in the LDPC encoding scheme based on the BG 1. This helps improve encoding performance.

According to the first aspect, in a possible implementation, the 1^{st}-stage information includes information about a resource occupied for decoding the 2^{nd}-stage information, and a length of the 1^{st}-stage information is less than or equal to a sixth length. It can be learned that the 1^{st}-stage information may include only the information about the resource occupied for decoding the 2^{nd}-stage information. This simplifies the 1^{st}-stage information, further reduces a payload length of the 1^{st}-stage information, and reduces blind detection complexity and blind detection overheads of the second communication apparatus.

According to the first aspect, in a possible implementation, the sixth length is 70.

According to the first aspect, in a possible implementation, the 1^{st}-stage information includes at least one of the following: a carrier indicator field, a bandwidth part indicator field, a time domain resource assignment field, a frequency domain resource assignment field, a virtual resource block (VRB) to physical resource block (PRB) mapping field, a PRB size indicator field, a reserved resource field, a zero-power channel state information reference signal (CSI-RS) trigger indicator field, a channel access type and cyclic extension field, a dormancy indication field, an invalid symbol pattern indicator field, or a scheduling offset indicator field.

According to the first aspect, in a possible implementation, the 1^{st}-stage information does not include at least one of the following: a shared channel indicator, a new data indicator, a redundancy version (RV), a priority indicator, a hybrid automatic repeat request (HARQ) process number, a downlink assignment index (DAI), physical downlink shared channel (PDSCH) to HARQ feedback timing, a code block group transmission indicator (CGBTI), code block group flush information (CBG flush information), a PDSCH group index, a number of requested PDSCH groups, a one-shot HARQ, a new feedback indicator, an antenna port, a transmission configuration indicator (TCI), a sounding reference signal (SRS) request, demodulation reference signal (DMRS) sequence initialization, or power control. This simplifies the 1^{st}-stage information, and further reduces the payload length of the 1^{st}-stage information.

According to the first aspect, in a possible implementation, the 2^{nd}-stage information includes at least one of the following: T-MIMO CSI, sensing-related information, artificial intelligence-related information, the shared channel indicator, the new data indicator, the redundancy version, the priority indicator, the HARQ process number, the downlink assignment index, the PDSCH-to-HARQ feedback timing, the code block group transmission indicator, the code block group flush information, the PDSCH group index, the number of requested PDSCH groups, the one-shot HARQ, the new feedback indicator, the antenna port, the transmission configuration indicator TCI, the sounding reference signal request, the DMRS sequence initialization, or the power control. In other words, a field originally carried in the 1^{st}-stage information is placed in the 2^{nd}-stage information, to simplify the 1^{st}-stage information, and reduce the blind detection overheads.

According to the first aspect, in a possible implementation, the 2^{nd}-stage information includes 2^{nd}-stage control information.

According to the first aspect, in a possible implementation, the 2^{nd}-stage control information is 2^{nd}-stage uplink control information (2^{nd}-stage UCI), or 2^{nd}-stage downlink control information (2^{nd}-stage DCI), or 2^{nd}-stage sidelink control information (2^{nd}-stage SCI). For different communication scenarios, there are some possible forms of the 2^{nd}-stage control information.

According to the first aspect, in a possible implementation, the 2^{nd}-stage information includes control information corresponding to the service. For example, for a sensing scenario, the 2^{nd}-stage information may be 2^{nd}-stage sensing control information. For an artificial intelligence training scenario, the 2^{nd}-stage information may be 2^{nd}-stage artificial intelligence control information.

According to the first aspect, in a possible implementation, the 2^{nd}-stage information includes layer 1 (L1) information.

According to the first aspect, in a possible implementation, the 2^{nd}-stage information includes at least one of the following: T-MIMO CSI, sensing-related information, or artificial intelligence-related information. In this way, several possible application scenarios of this disclosure are shown, and the information of these types may be understood as non-conventional communication information, that is, information transmitted at the layer 1.

According to the first aspect, in a possible implementation, the first communication apparatus is a terminal device, and the second communication apparatus is a network device; or the first communication apparatus is a network device, and the second communication apparatus is a terminal device; or the first communication apparatus is a first terminal device, and the second communication apparatus is a second terminal device.

A second aspect of this disclosure provides an information receiving method. The method may be performed by a second communication apparatus. The second communication apparatus may be a terminal device or a network device, or a component (for example, a processor, a chip, or a chip system) in a terminal device or a network device, or a logic module or software that can implement all or a part of functions of a terminal device, or a logic module or software that can implement all or a part of functions of a network device. The method includes:

A second communication apparatus receives 1^{st}-stage information and 2^{nd}-stage information that correspond to a same service type, where the 1^{st}-stage information is transmitted on a control channel and/or a shared channel, the 2^{nd}-stage information is transmitted on the shared channel, and the 1^{st}-stage information and 2^{nd}-stage information are for a same service; the second communication apparatus determines a decoding scheme and/or a segmentation scheme of the 2^{nd}-stage information according to a second rule; and the second communication apparatus decodes the 2^{nd}-stage information based on the decoding scheme and/or the segmentation scheme and the 1^{st}-stage information.

It can be learned from the technical solution that the second communication apparatus receives the 1^{st}-stage information and the 2^{nd}-stage information, and the second communication apparatus determines the decoding scheme and/or the segmentation scheme of the 2^{nd}-stage information according to the second rule. The second communication apparatus decodes the 2^{nd}-stage information based on the decoding scheme and/or the segmentation scheme and the 1^{st}-stage information. In this way, the 1^{st}-stage information and the 2^{nd}-stage information are transmitted between the first communication apparatus and the second communication apparatus. The second communication apparatus determines the decoding scheme and/or the segmentation scheme of the 2^{nd}-stage information according to the second rule. In this way, the second communication apparatus decodes the 2^{nd}-stage information based on the corresponding decoding scheme and/or segmentation scheme. This helps improve decoding performance of the 2^{nd}-stage information, and compensates for not supporting segmenting the 2^{nd}-stage information in a current communication protocol. In this way, the transmission manner of the 2^{nd}-stage information can adapt to different service scenarios of non-conventional communication information, thereby flexibly sending the 2^{nd}-stage information.

According to the second aspect, in a possible implementation, the second rule includes: segmenting the 2^{nd}-stage information based on a first length, and decoding segmented 2^{nd}-stage information based on a polar code decoding scheme, where the first length is 2ⁿ, and n is a positive integer. In this implementation, the second communication apparatus segments the 2^{nd}-stage information based on the first length by default. The second communication apparatus decodes the segmented 2^{nd}-stage information by default based on the polar code decoding scheme. In this way, the 2^{nd}-stage information is segmented and decoded, to improve decoding performance. There is no need to indicate the decoding scheme and the segmentation scheme via instruction signaling, thereby reducing signaling overheads.

According to the second aspect, in a possible implementation, the first length is less than 1024. In this implementation, the first length is less than a maximum decoding length supported by the polar code decoding scheme. This facilitates the second communication apparatus to decode the segmented 2^{nd}-stage information based on the polar code decoding scheme.

According to the second aspect, in a possible implementation, the first length is 32, 64, 128, 256, or 512.

According to the second aspect, in a possible implementation, the second rule includes: segmenting the 2^{nd}-stage information based on a second length, and decoding segmented 2^{nd}-stage information based on an LDPC decoding scheme. In this implementation, the second communication apparatus segments the 2^{nd}-stage information based on the second length by default, and decodes the 2^{nd}-stage information based on the LDPC decoding scheme by default. In this way, the 2^{nd}-stage information is segmented and decoded, to improve decoding performance. There is no need to indicate the decoding scheme and the segmentation scheme via instruction signaling, thereby reducing signaling overheads.

According to the second aspect, in a possible implementation, the second length is determined based on a payload size and a channel coding rate of the 2^{nd}-stage information. In this way, an appropriate segment length is selected based on an actual situation of the 2^{nd}-stage information. This helps improve decoding performance.

According to the second aspect, in a possible implementation, in correspondence to the payload size of the 2^{nd}-stage information less than or equal to 292, or in correspondence to the payload size of the 2^{nd}-stage information less than or equal to 3824 and the channel coding rate of the 2^{nd}-stage information less than or equal to 0.25, the 2^{nd}-stage information is segmented based on the second length of 3840, and LDPC decoding is performed on the segmented 2^{nd}-stage information based on a BG 2; or in correspondence to the payload size of the 2^{nd}-stage information greater than 292, or in correspondence to the payload size of the 2^{nd}-stage information greater than 3824 and the channel coding rate of the 2^{nd}-stage information greater than 0.25, the 2^{nd}-stage information is segmented based on the second length of 8448, and LDPC decoding is performed on the segmented 2^{nd}-stage information based on a BG 1. In this implementation, an appropriate segment length and an appropriate decoding scheme are selected based on the payload size and/or the channel coding rate of the 2^{nd}-stage information. For the 2^{nd}-stage information whose payload size is less than or equal to 292, or if the payload size of the 2^{nd}-stage information is less than or equal to 3824 and the channel coding rate of the 2^{nd}-stage information is less than or equal to 0.25, the second communication apparatus performs LDPC decoding on the segmented 2^{nd}-stage information based on the BG 2. The second length is 3840, that is, a maximum length supported by a decoding matrix used in the LDPC decoding scheme based on the BG 2. Otherwise, the second communication apparatus performs LDPC decoding on the segmented 2^{nd}-stage information based on the BG 1. The second length is 8448, that is, a maximum length supported by a decoding matrix used in the LDPC decoding scheme based on the BG 1. This helps improve decoding performance.

According to the second aspect, in a possible implementation, the second rule includes: determining the decoding scheme and/or the segmentation scheme of the 2^{nd}-stage information based on a payload size of the 2^{nd}-stage information and a channel coding rate of the 2^{nd}-stage information. In this implementation, the decoding scheme and/or the segmentation scheme of the 2^{nd}-stage information are/is determined based on the payload size of the 2^{nd}-stage information and the channel coding rate of the 2^{nd}-stage information. This helps improve decoding performance of the 2^{nd}-stage information. There is no need to indicate the decoding scheme and the segmentation scheme via instruction signaling, thereby reducing signaling overheads.

According to the second aspect, in a possible implementation, the second rule includes: in correspondence to the payload size of the 2^{nd}-stage information less than or equal to 384 and the channel coding rate of the 2^{nd}-stage information less than or equal to 0.5, or in correspondence to the payload size of the 2^{nd}-stage information less than or equal to 140, encoding the 2^{nd}-stage information based on a polar code decoding scheme without segmentation; or in correspondence to the payload size of the 2^{nd}-stage information greater than 384 and the channel coding rate of the 2^{nd}-stage information greater than 0.5, or in correspondence to the payload size of the 2^{nd}-stage information greater than 140, segmenting the 2^{nd}-stage information based on a segment length of 3840, and decoding segmented 2^{nd}-stage information based on an LDPC decoding scheme. In this implementation, when the payload size of the 2^{nd}-stage information is small and/or the channel coding rate is small, the second communication apparatus decodes the 2^{nd}-stage information based on the polar code decoding scheme without segmentation. Performance of polar code decoding is good, thereby helping improve decoding performance. Otherwise, when the payload size of the 2^{nd}-stage information is large and/or the channel coding rate is large, the second communication apparatus decodes the segmented 2^{nd}-stage information based on the LDPC decoding scheme. This helps improve decoding performance.

According to the second aspect, in a possible implementation, the second rule includes: determining the decoding scheme and/or the segmentation scheme of the 2^{nd}-stage information based on a length of the 2^{nd}-stage information received by the second communication apparatus, a number of available physical resources, and/or a modulation order. In this way, an appropriate decoding scheme and/or segmentation scheme are selected for the 2^{nd}-stage information, to improve decoding performance. There is no need to indicate the decoding scheme and the segmentation scheme via instruction signaling, thereby reducing signaling overheads.

According to the second aspect, in a possible implementation, the second rule includes: in correspondence to the length of the 2^{nd}-stage information received by the second communication apparatus less than or equal to a maximum length, determining a number of segments of the 2^{nd}-stage information based on a maximum decoding length supported by a polar code decoding scheme and the number of available physical resources, segmenting the 2^{nd}-stage information based on the number of segments of the 2^{nd}-stage information, and decoding segmented 2^{nd}-stage information based on the polar code decoding scheme; or in correspondence to the length of the 2^{nd}-stage information received by the second communication apparatus greater than the maximum length, determining a number of segments of the 2^{nd}-stage information based on a maximum decoding length supported by an LDPC decoding scheme and the number of available physical resources, segmenting the 2^{nd}-stage information based on the number of segments of the 2^{nd}-stage information, and decoding segmented 2^{nd}-stage information based on the LDPC decoding scheme. In this implementation, for the 2^{nd}-stage information whose length is less than or equal to the maximum length and that is received by the second communication apparatus, the second communication apparatus decodes the 2^{nd}-stage information based on the polar code decoding scheme, thereby improving decoding performance. The second communication apparatus determines the number of segments of the 2^{nd}-stage information based on the maximum decoding length supported by the polar code decoding scheme and the number of available physical resources, and segments the 2^{nd}-stage information based on the number of segments of the 2^{nd}-stage information. In this way, the second communication apparatus performs polar code decoding on the segmented 2^{nd}-stage information. Otherwise, the second communication apparatus decodes the 2^{nd}-stage information based on the LDPC decoding scheme, thereby improving decoding performance. The second communication apparatus determines the number of segments of the 2^{nd}-stage information based on the maximum decoding length supported by the LDPC decoding scheme and the number of available physical resources, segments the 2^{nd}-stage information based on the number of segments of the 2^{nd}-stage information, and decodes segmented 2^{nd}-stage information based on the LDPC decoding scheme. In this way, the second communication apparatus performs LDPC decoding on the segmented 2^{nd}-stage information.

According to the second aspect, in a possible implementation, the maximum decoding length supported by the polar decoding scheme is 1024.

According to the second aspect, in a possible implementation, the maximum decoding length supported by the LDPC decoding scheme is 3840.

According to the second aspect, in a possible implementation, the total number of available physical resources is Eₜₒₜₐₗ; the maximum decoding length supported by the polar decoding scheme or the maximum decoding length supported by the LDPC decoding scheme is represented as Nₘ; and if Eᵣₑₛₜ is less than

$$\frac{9 {N}_{m}}{16} ,$$

the number C of segments=C₁, or if Eᵣₑₛₜ is greater than or equal to

$$\frac{9 {N}_{m}}{16} ,$$

the number C of segments=C₁+1, where Eᵣₑₛₜ=Eₜₒₜₐₗ−C₁×Nₘ, and C₁=[Eₜₒₜₐₗ/Nₘ]. This helps improve decoding performance.

According to the second aspect, in a possible implementation, the 1^{st}-stage information includes first indication information, and the first indication information indicates an encoding scheme used for the 2^{nd}-stage information. In this way, the decoding scheme used for the 2^{nd}-stage information is indirectly indicated to the second communication apparatus based on the encoding scheme, so that no signaling indication is additionally required, and signaling overheads are reduced.

According to the second aspect, in a possible implementation, the first indication information is a first field in the 1^{st}-stage information.

According to the second aspect, in a possible implementation, when a value of the first field is 0, it indicates that the 2^{nd}-stage information is encoded by using a polar code encoding scheme; or when a value of the first field is 1, it indicates that the 2^{nd}-stage information is encoded based on an LDPC encoding scheme. In this way, the encoding scheme of the 2^{nd}-stage information is indicated, to facilitate the second communication apparatus to decode the 2^{nd}-stage information based on an appropriate decoding scheme, thereby improving decoding performance.

According to the second aspect, in a possible implementation, the second rule includes: in correspondence to the first indication information indicating that the polar code encoding scheme is used to encode the 2^{nd}-stage information, decoding the 2^{nd}-stage information based on a polar decoding scheme without segmentation; or in correspondence to the first indication information indicating that the LDPC encoding scheme is used to encode the 2^{nd}-stage information, segmenting the 2^{nd}-stage information based on a third length, and decoding segmented 2^{nd}-stage information based on an LDPC decoding scheme. In the implementation, a protocol may specify the segmentation scheme of the 2^{nd}-stage information based on the encoding scheme indicated by the first indication information. This facilitates the second communication apparatus to segment the 2^{nd}-stage information based on an appropriate segmentation scheme, and then decode segmented 2^{nd}-stage information.

According to the second aspect, in a possible implementation, the second rule includes: in correspondence to a modulation order of the 2^{nd}-stage information less than or equal to a first threshold, decoding the 2^{nd}-stage information based on a polar code decoding scheme without segmentation; or in correspondence to a modulation order of the 2^{nd}-stage information greater than the first threshold, segmenting the 2^{nd}-stage information based on a third length, and decoding segmented 2^{nd}-stage information based on an LDPC decoding scheme. When the modulation order is small, a payload length of the 2^{nd}-stage information is usually small, and the second communication apparatus uses the polar code decoding scheme to decode the 2^{nd}-stage information, thereby helping improve decoding performance. When the modulation order is large, a payload length of the 2^{nd}-stage information is usually large, and the second communication apparatus uses the LDPC decoding scheme to decode the 2^{nd}-stage information, so that decoding performance is good.

According to the second aspect, in a possible implementation, the third length is 3840 or 8448.

According to the second aspect, in a possible implementation, the second rule includes: in correspondence to the 2^{nd}-stage information that is first-type information, decoding the 2^{nd}-stage information based on a polar code decoding scheme without segmentation; or in correspondence to the 2^{nd}-stage information that is second-type information or third-type information, segmenting the 2^{nd}-stage information based on a fourth length, and decoding segmented 2^{nd}-stage information based on an LDPC decoding scheme. For the first-type information, a length of the 2^{nd}-stage information is usually small, and the second communication apparatus uses the polar code decoding scheme to decode the 2^{nd}-stage information, thereby helping improve decoding performance. For the second-type information or the third-type information, a payload length of the 2^{nd}-stage information is usually large, and the second communication apparatus uses the LDPC decoding scheme to decode the 2^{nd}-stage information, so that decoding performance is good.

According to the second aspect, in a possible implementation, the first-type information is T-MIMO CSI, the second-type information is sensing-related information, and the third-type information is artificial intelligence-related information. In this way, several possible application scenarios of this disclosure are shown, and the information of these types may be understood as non-conventional communication information, that is, information transmitted at the layer 1.

According to the second aspect, in a possible implementation, the fourth length is determined based on a payload size and a channel coding rate of the 2^{nd}-stage information. In this way, the segment length is determined based on a parameter of the 2^{nd}-stage information, to facilitate the second communication apparatus to encode the segmented 2^{nd}-stage information.

According to the second aspect, in a possible implementation, in correspondence to the payload size of the 2^{nd}-stage information less than or equal to 292, or in correspondence to the payload size of the 2^{nd}-stage information less than or equal to 3824 and the channel coding rate of the 2^{nd}-stage information less than or equal to 0.25, the 2^{nd}-stage information is segmented based on the fourth length of 3840, and LDPC decoding is performed on the segmented 2^{nd}-stage information based on a BG 2; or in correspondence to the payload size of the 2^{nd}-stage information greater than 292, or in correspondence to the payload size of the 2^{nd}-stage information greater than 3824 and the channel coding rate of the 2^{nd}-stage information greater than 0.25, the 2^{nd}-stage information is segmented based on the fourth length of 8448, and LDPC decoding is performed on the segmented 2^{nd}-stage information based on a BG 1. For the 2^{nd}-stage information whose payload size is less than or equal to 292, or for the 2^{nd}-stage information whose payload size is less than or equal to 3824 and channel coding rate is less than or equal to 0.25, the second communication apparatus performs LDPC decoding on the segmented 2^{nd}-stage information based on the BG 2. The fourth length is 3840, that is, a maximum length supported by a decoding matrix used in the LDPC decoding scheme based on the BG 2. Otherwise, the second communication apparatus performs LDPC decoding on the segmented 2^{nd}-stage information based on the BG 1. The fourth length is 8448, that is, a maximum length supported by a decoding matrix used in the LDPC decoding scheme based on the BG 1. This helps improve decoding performance.

According to the second aspect, in a possible implementation, the second rule includes: determining a fifth length based on a payload size and a channel coding rate of the 2^{nd}-stage information; and segmenting the 2^{nd}-stage information based on the fifth length, and decoding segmented 2^{nd}-stage information based on an LDPC decoding scheme. In this implementation, the second communication apparatus determines the segment length based on a parameter of the 2^{nd}-stage information, and decodes the segmented 2^{nd}-stage information based on the segment length. This helps improve decoding performance.

According to the second aspect, in a possible implementation, in correspondence to the payload size of the 2^{nd}-stage information less than or equal to 292, or in correspondence to the payload size of the 2^{nd}-stage information less than or equal to 3824 and the channel coding rate of the 2^{nd}-stage information less than or equal to 0.25, the fifth length is 3840; or in correspondence to the payload size of the 2^{nd}-stage information greater than 292, or in correspondence to the payload size of the 2^{nd}-stage information greater than 3824 and the channel coding rate of the 2^{nd}-stage information greater than 0.25, the fifth length is 8448.

According to the second aspect, in a possible implementation, the 1^{st}-stage information includes information about a resource occupied for decoding the 2^{nd}-stage information, and a length of the 1^{st}-stage information is less than or equal to a sixth length. It can be learned that the 1^{st}-stage information may include only the information about the resource occupied for decoding the 2^{nd}-stage information. This simplifies the 1^{st}-stage information, further reduces a payload length of the 1^{st}-stage information, and reduces blind detection complexity and blind detection overheads of the second communication apparatus.

According to the second aspect, in a possible implementation, the sixth length is 70.

According to the second aspect, in a possible implementation, the 1^{st}-stage information includes at least one of the following: a carrier indicator field, a bandwidth part indicator field, a time domain resource assignment field, a frequency domain resource assignment field, a VRB-to-PRB mapping field, a PRB size indicator field, a reserved resource field, a zero-power CSI-RS trigger indicator field, a channel access type and cyclic extension field, a dormancy indication field, an invalid symbol pattern indicator field, or a scheduling offset indicator field.

According to the second aspect, in a possible implementation, the 1^{st}-stage information does not include at least one of the following: a shared channel indicator, a new data indicator, a redundancy version, a priority indicator, a HARQ process number, a downlink assignment index, PDSCH-to-HARQ feedback timing, a code block group transmission indicator, code block group flush information, a PDSCH group index, a number of requested PDSCH groups, a one-shot HARQ, a new feedback indicator, an antenna port, a TCI, a sounding reference signal request, DMRS sequence initialization, or power control.

According to the second aspect, in a possible implementation, the 2^{nd}-stage information includes at least one of the following: T-MIMO CSI, sensing-related information, artificial intelligence-related information, the shared channel indicator, the new data indicator, the redundancy version, the priority indicator, the HARQ process number, the downlink assignment index, the PDSCH-to-HARQ feedback timing, the code block group transmission indicator, the code block group flush information, the PDSCH group index, the number of requested PDSCH groups, the one-shot HARQ, the new feedback indicator, the antenna port, the transmission configuration indicator TCI, the sounding reference signal request, the DMRS sequence initialization, or the power control.

According to the second aspect, in a possible implementation, the 2^{nd}-stage information includes 2^{nd}-stage control information.

According to the second aspect, in a possible implementation, the 2^{nd}-stage control information is 2^{nd}-stage UCI, or 2^{nd}-stage DCI, or 2^{nd}-stage SCI.

According to the second aspect, in a possible implementation, the 2^{nd}-stage information includes L1 information.

According to the second aspect, in a possible implementation, the 2^{nd}-stage information includes at least one of the following: T-MIMO CSI, sensing-related information, or artificial intelligence-related information.

According to the second aspect, in a possible implementation, the first communication apparatus is a terminal device, and the second communication apparatus is a network device; or the first communication apparatus is a network device, and the second communication apparatus is a terminal device; or the first communication apparatus is a first terminal device, and the second communication apparatus is a second terminal device.

A third aspect of this disclosure provides an information sending method. The method may be performed by a first communication apparatus. The first communication apparatus may be a terminal device or a network device, or a component (for example, a processor, a chip, or a chip system) in a terminal device or a network device, or a logic module or software that can implement all or a part of functions of a terminal device, or a logic module or software that can implement all or a part of functions of a network device. The method includes:

The first communication apparatus determines 1^{st}-stage information, where the 1^{st}-stage information includes information about a resource occupied for decoding 2^{nd}-stage information, and a length of the 1^{st}-stage information is less than or equal to a first length; and the first communication apparatus outputs the 1^{st}-stage information. It can be learned that the 1^{st}-stage information may include only the information about the resource occupied for decoding the 2^{nd}-stage information. This simplifies the 1^{st}-stage information, further reduces a payload length of the 1^{st}-stage information, and reduces blind detection complexity and blind detection overheads of the second communication apparatus.

A fourth aspect of this disclosure provides an information receiving method. The method may be performed by a second communication apparatus. The second communication apparatus may be a terminal device or a network device, or a component (for example, a processor, a chip, or a chip system) in a terminal device or a network device, or a logic module or software that can implement all or a part of functions of a terminal device, or a logic module or software that can implement all or a part of functions of a network device. The method includes:

The second communication apparatus receives 1^{st}-stage information, where the 1^{st}-stage information includes information about a resource occupied for decoding 2^{nd}-stage information, and a length of the 1^{st}-stage information is less than or equal to a first length. It can be learned that the 1^{st}-stage information may include only the information about the resource occupied for decoding the 2^{nd}-stage information. This simplifies the 1^{st}-stage information, further reduces a payload length of the 1^{st}-stage information, and reduces blind detection complexity and blind detection overheads of the second communication apparatus.

According to the third aspect or the fourth aspect, in a possible implementation, the first length is 70.

According to the third aspect or the fourth aspect, in a possible implementation, the 1st-stage information includes at least one of the following: a carrier indicator field, a bandwidth part indicator field, a time domain resource assignment field, a frequency domain resource assignment field, a VRB-to-PRB mapping field, a PRB size indicator field, a reserved resource field, a zero-power CSI-RS trigger indicator field, a channel access type and cyclic extension field, a dormancy indication field, an invalid symbol pattern indicator field, or a scheduling offset indicator field. The 1^{st}-stage information may include only one or more of the foregoing fields. In this way, the 1^{st}-stage information is simplified.

According to the third aspect or the fourth aspect, in a possible implementation, the 1st-stage information includes 1^{st}-stage control information.

According to the third aspect or the fourth aspect, in a possible implementation, the 1st-stage control information is 1^{st}-stage downlink control information (1^{st}-stage DCI), or 1^{st}-stage uplink control information (1^{st}-stage UCI), or 1^{st}-stage sidelink control information (1^{st}-stage SCI). For different communication scenarios, there are some possible forms of the 1^{st}-stage control information.

According to the third aspect, in a possible implementation, the 1^{st}-stage information is for decoding 2^{nd}-stage information; and the method further includes: the first communication apparatus sends the 2^{nd}-stage information, where the 1^{st}-stage information and the 2^{nd}-stage information correspond to a same service type.

According to the fourth aspect, in a possible implementation, the 1^{st}-stage information is for decoding 2^{nd}-stage information; and the method further includes: the second communication apparatus receives the 2^{nd}-stage information, where the 1^{st}-stage information and the 2^{nd}-stage information correspond to a same service type.

According to the third aspect or the fourth aspect, in a possible implementation, the 2^{nd}-stage information includes 2^{nd}-stage control information.

According to the third aspect or the fourth aspect, in a possible implementation, the 2^{nd}-stage control information is 2^{nd}-stage UCI, or 2^{nd}-stage DCI, or 2^{nd}-stage SCI.

According to the third aspect or the fourth aspect, in a possible implementation, the 1st-stage information does not include at least one of the following: a shared channel indicator, a new data indicator, a redundancy version, a priority indicator, a HARQ process number, a downlink assignment index, PDSCH-to-HARQ feedback timing, a code block group transmission indicator, code block group flush information, a PDSCH group index, a number of requested PDSCH groups, a one-shot HARQ, a new feedback indicator, an antenna port, a transmission configuration indicator TCI, a sounding reference signal request, DMRS sequence initialization, or power control.

According to the third aspect or the fourth aspect, in a possible implementation, the 2^{nd}-stage information includes at least one of the following: T-MIMO CSI, sensing-related information, artificial intelligence-related information, the shared channel indicator, the new data indicator, the redundancy version, the priority indicator, the HARQ process number, the downlink assignment index, the PDSCH-to-HARQ feedback timing, the code block group transmission indicator, the code block group flush information, the PDSCH group index, the number of requested PDSCH groups, the one-shot HARQ, the new feedback indicator, the antenna port, the transmission configuration indicator TCI, the sounding reference signal request, the DMRS sequence initialization, or the power control.

According to the third aspect or the fourth aspect, in a possible implementation, the 2^{nd}-stage information includes L1 information.

According to the third aspect or the fourth aspect, in a possible implementation, the 2^{nd}-stage information includes at least one of the following: T-MIMO CSI, sensing-related information, or artificial intelligence-related information.

According to the third aspect or the fourth aspect, in a possible implementation, the first communication apparatus is a terminal device, and the second communication apparatus is a network device; or the first communication apparatus is a network device, and the second communication apparatus is a terminal device; or the first communication apparatus is a first terminal device, and the second communication apparatus is a second terminal device.

A fifth aspect of this disclosure provides a first communication apparatus, including: a processing module, configured to determine 1^{st}-stage information and 2^{nd}-stage information that correspond to a same service type, where the 1^{st}-stage information is transmitted on a control channel and/or a shared channel, the 2^{nd}-stage information is transmitted on the shared channel, the 2^{nd}-stage information is generated based on an encoding scheme and/or a segmentation scheme determined according to a first rule, and the 1^{st}-stage information is for decoding the 2^{nd}-stage information; and a transceiver module, configured to output the 1^{st}-stage information and the 2^{nd}-stage information.

According to the fifth aspect, in a possible implementation, the first rule includes: segmenting the 2^{nd}-stage information based on a first length, and encoding segmented 2^{nd}-stage information by the first communication apparatus based on a polar code encoding scheme, where the first length is 2ⁿ, and n is a positive integer.

According to the fifth aspect, in a possible implementation, the first length is less than 1024.

According to the fifth aspect, in a possible implementation, the first length is 32, 64, 128, 256, or 512.

According to the fifth aspect, in a possible implementation, the first rule includes: segmenting the 2^{nd}-stage information based on a second length, and encoding segmented 2^{nd}-stage information by the first communication apparatus based on an LDPC encoding scheme.

According to the fifth aspect, in a possible implementation, the second length is determined based on a payload size and a channel coding rate of the 2^{nd}-stage information.

According to the fifth aspect, in a possible implementation, in correspondence to the payload size of the 2^{nd}-stage information less than or equal to 292, or in correspondence to the payload size of the 2^{nd}-stage information less than or equal to 3824 and the channel coding rate of the 2^{nd}-stage information less than or equal to 0.25, the 2^{nd}-stage information is segmented based on the second length of 3840, and LDPC encoding is performed on the segmented 2^{nd}-stage information based on a BG 2; or in correspondence to the payload size of the 2^{nd}-stage information greater than 292, or in correspondence to the payload size of the 2^{nd}-stage information greater than 3824 and the channel coding rate of the 2^{nd}-stage information greater than 0.25, the 2^{nd}-stage information is segmented based on the second length of 8448, and LDPC encoding is performed on the segmented 2^{nd}-stage information based on a BG 1.

According to the fifth aspect, in a possible implementation, the first rule includes: determining the encoding scheme and/or the segmentation scheme of the 2^{nd}-stage information based on a payload size of the 2^{nd}-stage information and a channel coding rate of the 2^{nd}-stage information.

According to the fifth aspect, in a possible implementation, the first rule includes: in correspondence to the payload size of the 2^{nd}-stage information less than or equal to 384 and the channel coding rate of the 2^{nd}-stage information less than or equal to 0.5, or in correspondence to the payload size of the 2^{nd}-stage information less than or equal to 140, encoding the 2^{nd}-stage information based on a polar code encoding scheme without segmentation; or in correspondence to the payload size of the 2^{nd}-stage information greater than 384 and the channel coding rate of the 2^{nd}-stage information greater than 0.5, or in correspondence to the payload size of the 2^{nd}-stage information greater than 140, segmenting the 2^{nd}-stage information based on a segment length of 3840, and encoding segmented 2^{nd}-stage information based on an LDPC encoding scheme.

According to the fifth aspect, in a possible implementation, the first rule includes: determining the encoding scheme and/or the segmentation scheme of the 2^{nd}-stage information based on a length of rate-matched 2^{nd}-stage information, a number of available physical resources, and/or a modulation order.

According to the fifth aspect, in a possible implementation, the first rule includes: in correspondence to the length of the rate-matched 2^{nd}-stage information less than or equal to a maximum length, determining a number of segments of the 2^{nd}-stage information based on a maximum encoding length supported by a polar code encoding scheme and the number of available physical resources, segmenting the 2^{nd}-stage information based on the number of segments of the 2^{nd}-stage information, and encoding segmented 2^{nd}-stage information based on the polar code encoding scheme; or in correspondence to the length of the rate-matched 2^{nd}-stage information greater than the maximum length, determining a number of segments of the 2^{nd}-stage information based on a maximum encoding length supported by an LDPC encoding scheme and the number of available physical resources, segmenting the 2^{nd}-stage information based on the number of segments of the 2^{nd}-stage information, and encoding segmented 2^{nd}-stage information based on the LDPC encoding scheme, where the maximum length is determined based on the number of available resources and the modulation order.

According to the fifth aspect, in a possible implementation, the maximum encoding length supported by the polar encoding scheme is 1024.

According to the fifth aspect, in a possible implementation, the maximum encoding length supported by the LDPC encoding scheme is 3840.

According to the fifth aspect, in a possible implementation, the number of available physical resources is Eₜₒₜₐₗ; the maximum encoding length supported by the polar encoding scheme or the maximum encoding length supported by the LDPC encoding scheme is represented as Nₘ; and if Eᵣₑₛₜ is less than

$$\frac{9 {N}_{m}}{16} ,$$

the number C of segments=C₁, or if Eᵣₑₛₜ is greater than or equal to

$$\frac{9 {N}_{m}}{16} ,$$

the number C of segments=C₁+1, where Eᵣₑₛₜ=Eₜₒₜₐₗ−C₁×Nₘ, and C₁=[Eₜₒₜₐₗ/Nₘ].

According to the fifth aspect, in a possible implementation, the 1^{st}-stage information includes first indication information, and the first indication information indicates an encoding scheme used for the 2^{nd}-stage information.

According to the fifth aspect, in a possible implementation, the first indication information is a first field in the 1^{st}-stage information.

According to the fifth aspect, in a possible implementation, when a value of the first field is 0, it indicates that the 2^{nd}-stage information is encoded by using a polar code encoding scheme; or when a value of the first field is 1, it indicates that the 2^{nd}-stage information is encoded based on an LDPC encoding scheme.

According to the fifth aspect, in a possible implementation, the first rule includes: in correspondence to the first indication information indicating that the polar code encoding scheme is used to encode the 2^{nd}-stage information, encoding the 2^{nd}-stage information without segmentation; or in correspondence to the first indication information indicating that the LDPC encoding scheme is used to encode the 2^{nd}-stage information, segmenting the 2^{nd}-stage information based on a third length.

According to the fifth aspect, in a possible implementation, the first rule includes: in correspondence to a modulation order of the 2^{nd}-stage information less than or equal to a first threshold, encoding the 2^{nd}-stage information based on a polar code encoding scheme without segmentation; or in correspondence to a modulation order of the 2^{nd}-stage information greater than the first threshold, segmenting the 2^{nd}-stage information based on a third length, and encoding segmented 2^{nd}-stage information based on an LDPC encoding scheme.

According to the fifth aspect, in a possible implementation, the third length is 3840 or 8448.

According to the fifth aspect, in a possible implementation, the first rule includes: in correspondence to the 2^{nd}-stage information that is first-type information, encoding the 2^{nd}-stage information based on a polar code encoding scheme without segmentation; or in correspondence to the 2^{nd}-stage information that is second-type information or third-type information, segmenting the 2^{nd}-stage information based on a fourth length, and encoding segmented 2^{nd}-stage information based on an LDPC encoding scheme.

According to the fifth aspect, in a possible implementation, the first-type information is T-MIMO CSI, the second-type information is sensing-related information, and the third-type information is artificial intelligence-related information.

According to the fifth aspect, in a possible implementation, the fourth length is determined based on a payload size and a channel coding rate of the 2^{nd}-stage information.

According to the fifth aspect, in a possible implementation, in correspondence to the payload size of the 2^{nd}-stage information less than or equal to 292, or in correspondence to the payload size of the 2^{nd}-stage information less than or equal to 3824 and the channel coding rate of the 2^{nd}-stage information less than or equal to 0.25, the 2^{nd}-stage information is segmented based on the fourth length of 3840, and LDPC encoding is performed on the segmented 2^{nd}-stage information based on a base graph BG 2; or in correspondence to the payload size of the 2^{nd}-stage information greater than 292, or in correspondence to the payload size of the 2^{nd}-stage information greater than 3824 and the channel coding rate of the 2^{nd}-stage information greater than 0.25, the 2^{nd}-stage information is segmented based on the fourth length of 8448, and LDPC encoding is performed on the segmented 2^{nd}-stage information based on a BG 1.

According to the fifth aspect, in a possible implementation, the first rule includes: determining a fifth length based on a payload size and a channel coding rate of the 2^{nd}-stage information; and segmenting the 2^{nd}-stage information based on the fifth length, and then encoding segmented 2^{nd}-stage information based on an LDPC encoding scheme.

According to the fifth aspect, in a possible implementation, in correspondence to the payload size of the 2^{nd}-stage information less than or equal to 292, or in correspondence to the payload size of the 2^{nd}-stage information less than or equal to 3824 and the channel coding rate of the 2^{nd}-stage information less than or equal to 0.25, the fifth length is 3840; or in correspondence to the payload size of the 2^{nd}-stage information greater than 292, or in correspondence to the payload size of the 2^{nd}-stage information greater than 3824 and the channel coding rate of the 2^{nd}-stage information greater than 0.25, the fifth length is 8448.

According to the fifth aspect, in a possible implementation, the 1^{st}-stage information includes information about a resource occupied for decoding the 2^{nd}-stage information, and a length of the 1^{st}-stage information is less than or equal to a sixth length.

According to the fifth aspect, in a possible implementation, the sixth length is 70.

According to the fifth aspect, in a possible implementation, the 1^{st}-stage information includes at least one of the following: a carrier indicator field, a bandwidth part indicator field, a time domain resource assignment field, a frequency domain resource assignment field, a VRB-to-PRB mapping field, a PRB size indicator field, a reserved resource field, a zero-power CSI-RS trigger indicator field, a channel access type and cyclic extension field, a dormancy indication field, an invalid symbol pattern indicator field, or a scheduling offset indicator field.

According to the fifth aspect, in a possible implementation, the 1^{st}-stage information does not include at least one of the following: a shared channel indicator, a new data indicator, a redundancy version, a priority indicator, a HARQ process number, a downlink assignment index, PDSCH-to-HARQ feedback timing, a code block group transmission indicator, code block group flush information, a PDSCH group index, a number of requested PDSCH groups, a one-shot HARQ, a new feedback indicator, an antenna port, a TCI, a sounding reference signal request, DMRS sequence initialization, or power control.

According to the fifth aspect, in a possible implementation, the 2^{nd}-stage information includes at least one of the following: T-MIMO CSI, sensing-related information, artificial intelligence-related information, the shared channel indicator, the new data indicator, the redundancy version, the priority indicator, the HARQ process number, the downlink assignment index, the PDSCH-to-HARQ feedback timing, the code block group transmission indicator, the code block group flush information, the PDSCH group index, the number of requested PDSCH groups, the one-shot HARQ, the new feedback indicator, the antenna port, the transmission configuration indicator TCI, the sounding reference signal request, the DMRS sequence initialization, or the power control.

According to the fifth aspect, in a possible implementation, the 2^{nd}-stage information includes 2^{nd}-stage control information.

According to the fifth aspect, in a possible implementation, the 2^{nd}-stage control information is 2^{nd}-stage UCI, or 2^{nd}-stage DCI, or 2^{nd}-stage SCI.

According to the fifth aspect, in a possible implementation, the 2^{nd}-stage information includes control information corresponding to the service.

According to the fifth aspect, in a possible implementation, the 2^{nd}-stage information includes L1 information.

According to the fifth aspect, in a possible implementation, the 2^{nd}-stage information includes at least one of the following: T-MIMO CSI, sensing-related information, or artificial intelligence-related information.

According to the fifth aspect, in a possible implementation, the first communication apparatus is a terminal device, and the second communication apparatus is a network device; or the first communication apparatus is a network device, and the second communication apparatus is a terminal device; or the first communication apparatus is a first terminal device, and the second communication apparatus is a second terminal device.

A sixth aspect of this disclosure provides a second communication apparatus, including: a transceiver module, configured to receive 1^{st}-stage information and 2^{nd}-stage information that correspond to a same service type, where the 1^{st}-stage information is transmitted on a control channel and/or a shared channel, and the 2^{nd}-stage information is transmitted on the shared channel; and a processing module, configured to: determine a decoding scheme and/or a segmentation scheme of the 2^{nd}-stage information according to a second rule, and decode the 2^{nd}-stage information based on a decoding scheme and/or a segmentation scheme and the 1^{st}-stage information.

According to the sixth aspect, in a possible implementation, the second rule includes: segmenting the 2^{nd}-stage information based on a first length, and decoding segmented 2^{nd}-stage information based on a polar code decoding scheme, where the first length is 2ⁿ, and n is a positive integer.

According to the sixth aspect, in a possible implementation, the first length is less than 1024.

According to the sixth aspect, in a possible implementation, the first length is 32, 64, 128, 256, or 512.

According to the sixth aspect, in a possible implementation, the second rule includes: segmenting the 2^{nd}-stage information based on a second length, and decoding segmented 2^{nd}-stage information based on an LDPC decoding scheme.

According to the sixth aspect, in a possible implementation, the second length is determined based on a payload size and a channel coding rate of the 2^{nd}-stage information.

According to the sixth aspect, in a possible implementation, in correspondence to the payload size of the 2^{nd}-stage information less than or equal to 292, or in correspondence to the payload size of the 2^{nd}-stage information less than or equal to 3824 and the channel coding rate of the 2^{nd}-stage information less than or equal to 0.25, the 2^{nd}-stage information is segmented based on the second length of 3840, and LDPC decoding is performed on the segmented 2^{nd}-stage information based on a BG 2; or in correspondence to the payload size of the 2^{nd}-stage information greater than 292, or in correspondence to the payload size of the 2^{nd}-stage information greater than 3824 and the channel coding rate of the 2^{nd}-stage information greater than 0.25, the 2^{nd}-stage information is segmented based on the second length of 8448, and LDPC decoding is performed on the segmented 2^{nd}-stage information based on a BG 1.

According to the sixth aspect, in a possible implementation, the second rule includes: determining the decoding scheme and/or the segmentation scheme of the 2^{nd}-stage information based on a payload size of the 2^{nd}-stage information and a channel coding rate of the 2^{nd}-stage information.

According to the sixth aspect, in a possible implementation, the second rule includes: in correspondence to the payload size of the 2^{nd}-stage information less than or equal to 384 and the channel coding rate of the 2^{nd}-stage information less than or equal to 0.5, or in correspondence to the payload size of the 2^{nd}-stage information less than or equal to 140, encoding the 2^{nd}-stage information based on a polar code decoding scheme without segmentation; or in correspondence to the payload size of the 2^{nd}-stage information greater than 384 and the channel coding rate of the 2^{nd}-stage information greater than 0.5, or in correspondence to the payload size of the 2^{nd}-stage information greater than 140, segmenting the 2^{nd}-stage information based on a segment length of 3840, and decoding segmented 2^{nd}-stage information based on an LDPC decoding scheme.

According to the sixth aspect, in a possible implementation, the second rule includes: determining the decoding scheme and/or the segmentation scheme of the 2^{nd}-stage information based on a length of 2^{nd}-stage information received by the second communication apparatus, a number of available physical resources, and/or a modulation order.

According to the sixth aspect, in a possible implementation, the second rule includes: in correspondence to the length of the 2^{nd}-stage information received by the second communication apparatus less than or equal to a maximum length, determining a number of segments of the 2^{nd}-stage information based on a maximum decoding length supported by a polar code decoding scheme and the number of available physical resources, segmenting the 2^{nd}-stage information based on the number of segments of the 2^{nd}-stage information, and decoding segmented 2^{nd}-stage information based on the polar code decoding scheme; or in correspondence to the length of the 2^{nd}-stage information received by the second communication apparatus greater than the maximum length, determining a number of segments of the 2^{nd}-stage information based on a maximum decoding length supported by an LDPC decoding scheme and the number of available physical resources, segmenting the 2^{nd}-stage information based on the number of segments of the 2^{nd}-stage information, and decoding segmented 2^{nd}-stage information based on the LDPC decoding scheme.

According to the sixth aspect, in a possible implementation, the maximum decoding length supported by the polar decoding scheme is 1024.

According to the sixth aspect, in a possible implementation, the maximum decoding length supported by the LDPC decoding scheme is 3840.

According to the sixth aspect, in a possible implementation, the total number of available physical resources is Eₜₒₜₐₗ; the maximum decoding length supported by the polar decoding scheme or the maximum decoding length supported by the LDPC decoding scheme is represented as Nₘ; and if Eᵣₑₛₜ is less than

$$\frac{9 {N}_{m}}{16} ,$$

the number C of segments=C₁, or if Eᵣₑₛₜ is greater than or equal to

$$\frac{9 {N}_{m}}{16} ,$$

the number C of segments=C₁+1, where Eᵣₑₛₜ=Eₜₒₜₐₗ−C₁×Nₘ, and C₁=[Eₜₒₜₐₗ/Nₘ].

According to the sixth aspect, in a possible implementation, the 1^{st}-stage information includes first indication information, and the first indication information indicates an encoding scheme used for the 2^{nd}-stage information.

According to the sixth aspect, in a possible implementation, the first indication information is a first field in the 1^{st}-stage information.

According to the sixth aspect, in a possible implementation, when a value of the first field is 0, it indicates that the 2^{nd}-stage information is encoded by using a polar code encoding scheme; or when a value of the first field is 1, it indicates that the 2^{nd}-stage information is encoded based on an LDPC encoding scheme.

According to the sixth aspect, in a possible implementation, the second rule includes: in correspondence to the first indication information indicating that the polar code encoding scheme is used to encode the 2^{nd}-stage information, decoding the 2^{nd}-stage information based on a polar decoding scheme without segmentation; or in correspondence to the first indication information indicating that the LDPC encoding scheme is used to encode the 2^{nd}-stage information, segmenting the 2^{nd}-stage information based on a third length, and decoding segmented 2^{nd}-stage information based on an LDPC decoding scheme.

According to the sixth aspect, in a possible implementation, the second rule includes: in correspondence to a modulation order of the 2^{nd}-stage information less than or equal to a first threshold, decoding the 2^{nd}-stage information based on a polar code decoding scheme without segmentation; or in correspondence to a modulation order of the 2^{nd}-stage information greater than the first threshold, segmenting the 2^{nd}-stage information based on a third length, and decoding segmented 2^{nd}-stage information based on an LDPC decoding scheme.

According to the sixth aspect, in a possible implementation, the third length is 3840 or 8448.

According to the sixth aspect, in a possible implementation, the second rule includes: in correspondence to the 2^{nd}-stage information that is first-type information, decoding the 2^{nd}-stage information based on a polar code decoding scheme without segmentation; or in correspondence to the 2^{nd}-stage information that is second-type information or third-type information, segmenting the 2^{nd}-stage information based on a fourth length, and decoding segmented 2^{nd}-stage information based on an LDPC decoding scheme.

According to the sixth aspect, in a possible implementation, the first-type information is T-MIMO CSI, the second-type information is sensing-related information, and the third-type information is artificial intelligence-related information.

According to the sixth aspect, in a possible implementation, the fourth length is determined based on a payload size and a channel coding rate of the 2^{nd}-stage information.

According to the sixth aspect, in a possible implementation, in correspondence to the payload size of the 2^{nd}-stage information less than or equal to 292, or in correspondence to the payload size of the 2^{nd}-stage information less than or equal to 3824 and the channel coding rate of the 2^{nd}-stage information less than or equal to 0.25, the 2^{nd}-stage information is segmented based on the fourth length of 3840, and LDPC decoding is performed on the segmented 2^{nd}-stage information based on a BG 2; or in correspondence to the payload size of the 2^{nd}-stage information greater than 292, or in correspondence to the payload size of the 2^{nd}-stage information greater than 3824 and the channel coding rate of the 2^{nd}-stage information greater than 0.25, the 2^{nd}-stage information is segmented based on the fourth length of 8448, and LDPC decoding is performed on the segmented 2^{nd}-stage information based on a BG 1.

According to the sixth aspect, in a possible implementation, the second rule includes: determining a fifth length based on a payload size and a channel coding rate of the 2^{nd}-stage information; and segmenting the 2^{nd}-stage information based on the fifth length, and decoding segmented 2^{nd}-stage information based on an LDPC decoding scheme.

According to the sixth aspect, in a possible implementation, in correspondence to the payload size of the 2^{nd}-stage information less than or equal to 292, or in correspondence to the payload size of the 2^{nd}-stage information less than or equal to 3824 and the channel coding rate of the 2^{nd}-stage information less than or equal to 0.25, the fifth length is 3840; or in correspondence to the payload size of the 2^{nd}-stage information greater than 292, or in correspondence to the payload size of the 2^{nd}-stage information greater than 3824 and the channel coding rate of the 2^{nd}-stage information greater than 0.25, the fifth length is 8448.

According to the sixth aspect, in a possible implementation, the 1^{st}-stage information includes information about a resource occupied for decoding the 2^{nd}-stage information, and a length of the 1^{st}-stage information is less than or equal to a sixth length.

According to the sixth aspect, in a possible implementation, the sixth length is 70.

According to the sixth aspect, in a possible implementation, the 1^{st}-stage information includes at least one of the following: a carrier indicator field, a bandwidth part indicator field, a time domain resource assignment field, a frequency domain resource assignment field, a VRB-to-PRB mapping field, a PRB size indicator field, a reserved resource field, a zero-power CSI-RS trigger indicator field, a channel access type and cyclic extension field, a dormancy indication field, an invalid symbol pattern indicator field, or a scheduling offset indicator field.

According to the sixth aspect, in a possible implementation, the 1^{st}-stage information does not include at least one of the following: a shared channel indicator, a new data indicator, a redundancy version, a priority indicator, a HARQ process number, a downlink assignment index, PDSCH-to-HARQ feedback timing, a code block group transmission indicator, code block group flush information, a PDSCH group index, a number of requested PDSCH groups, a one-shot HARQ, a new feedback indicator, an antenna port, a transmission configuration indicator TCI, a sounding reference signal request, DMRS sequence initialization, or power control.

According to the sixth aspect, in a possible implementation, the 2^{nd}-stage information includes at least one of the following: T-MIMO CSI, sensing-related information, artificial intelligence-related information, the shared channel indicator, the new data indicator, the redundancy version, the priority indicator, the HARQ process number, the downlink assignment index, the PDSCH-to-HARQ feedback timing, the code block group transmission indicator, the code block group flush information, the PDSCH group index, the number of requested PDSCH groups, the one-shot HARQ, the new feedback indicator, the antenna port, the transmission configuration indicator TCI, the sounding reference signal request, the DMRS sequence initialization, or the power control.

According to the sixth aspect, in a possible implementation, the 2^{nd}-stage information includes 2^{nd}-stage control information.

According to the sixth aspect, in a possible implementation, the 2^{nd}-stage control information is 2^{nd}-stage UCI, or 2^{nd}-stage DCI, or 2^{nd}-stage SCI.

According to the sixth aspect, in a possible implementation, the 2^{nd}-stage information includes L1 information.

According to the sixth aspect, in a possible implementation, the 2^{nd}-stage information includes at least one of the following: T-MIMO CSI, sensing-related information, or artificial intelligence-related information.

According to the sixth aspect, in a possible implementation, the first communication apparatus is a terminal device, and the second communication apparatus is a network device; or the first communication apparatus is a network device, and the second communication apparatus is a terminal device; or the first communication apparatus is a first terminal device, and the second communication apparatus is a second terminal device.

A seventh aspect of this disclosure provides a first communication apparatus, including: a processing module, configured to determine 1^{st}-stage information, where the 1^{st}-stage information includes information about a resource occupied for decoding 2^{nd}-stage information, and a length of the 1^{st}-stage information is less than or equal to a first length; and a transceiver module, configured to output the 1^{st}-stage information.

According to an eighth aspect of this disclosure, a second communication apparatus is provided, including: a transceiver module, configured to receive 1^{st}-stage information, where the 1^{st}-stage information includes information about a resource occupied for decoding 2^{nd}-stage information, and a length of the 1^{st}-stage information is less than or equal to a first length.

According to the seventh aspect or the eighth aspect, in a possible implementation, the first length is 70.

According to the seventh aspect or the eighth aspect, in a possible implementation, the 1^{st}-stage information includes at least one of the following: a carrier indicator field, a bandwidth part indicator field, a time domain resource assignment field, a frequency domain resource assignment field, a VRB-to-PRB mapping field, a PRB size indicator field, a reserved resource field, a zero-power CSI-RS trigger indicator field, a channel access type and cyclic extension field, a dormancy indication field, an invalid symbol pattern indicator field, or a scheduling offset indicator field. The 1^{st}-stage information may include only one or more of the foregoing fields. In this way, the 1^{st}-stage information is simplified.

According to the seventh aspect or the eighth aspect, in a possible implementation, the 1^{st}-stage information includes 1^{st}-stage control information.

According to the seventh aspect or the eighth aspect, in a possible implementation, the 1^{st}-stage control information is 1^{st}-stage DCI, 1^{st}-stage UCI, or 1^{st}-stage SCI.

According to the seventh aspect, in a possible implementation, the 1^{st}-stage information is for decoding 2^{nd}-stage information; and the transceiver module is further configured to send the 2^{nd}-stage information, where the 1^{st}-stage information and the 2^{nd}-stage information correspond to a same service type.

According to the eighth aspect, in a possible implementation, the 1^{st}-stage information is for decoding 2^{nd}-stage information; and the transceiver module is further configured to receive the 2^{nd}-stage information, where the 1^{st}-stage information and the 2^{nd}-stage information correspond to a same service type.

According to the seventh aspect or the eighth aspect, in a possible implementation, the 2^{nd}-stage information includes 2^{nd}-stage control information.

According to the seventh aspect or the eighth aspect, in a possible implementation, the 2^{nd}-stage control information is 2^{nd}-stage UCI, or 2^{nd}-stage DCI, or 2^{nd}-stage SCI.

According to the seventh aspect or the eighth aspect, in a possible implementation, the 1^{st}-stage information does not include at least one of the following: a shared channel indicator, a new data indicator, a redundancy version, a priority indicator, a HARQ process number, a downlink assignment index, PDSCH-to-HARQ feedback timing, a code block group transmission indicator, code block group flush information, a PDSCH group index, a number of requested PDSCH groups, a one-shot HARQ, a new feedback indicator, an antenna port, a transmission configuration indicator TCI, a sounding reference signal request, DMRS sequence initialization, or power control.

According to the seventh aspect or the eighth aspect, in a possible implementation, the 2^{nd}-stage information includes at least one of the following: T-MIMO CSI, sensing-related information, artificial intelligence-related information, the shared channel indicator, the new data indicator, the redundancy version, the priority indicator, the HARQ process number, the downlink assignment index, the PDSCH-to-HARQ feedback timing, the code block group transmission indicator, the code block group flush information, the PDSCH group index, the number of requested PDSCH groups, the one-shot HARQ, the new feedback indicator, the antenna port, the transmission configuration indicator TCI, the sounding reference signal request, the DMRS sequence initialization, or the power control.

According to the seventh aspect or the eighth aspect, in a possible implementation, the 2^{nd}-stage information includes L1 information.

According to the seventh aspect or the eighth aspect, in a possible implementation, the 2^{nd}-stage information includes at least one of the following: T-MIMO CSI, sensing-related information, or artificial intelligence-related information.

According to the seventh aspect or the eighth aspect, in a possible implementation, the first communication apparatus is a terminal device, and the second communication apparatus is a network device; or the first communication apparatus is a network device, and the second communication apparatus is a terminal device; or the first communication apparatus is a first terminal device, and the second communication apparatus is a second terminal device.

An eighth aspect of this disclosure provides a computer program product including computer instructions. When the computer program product runs on a computer, the computer is enabled to perform any one of the implementations according to the first aspect to the fourth aspect.

A ninth aspect of this disclosure provides a computer-readable storage medium, including computer instructions. When the computer instructions are run on a computer, the computer is enabled to perform any one of the implementations according to the first aspect to the fourth aspect.

A tenth aspect of this disclosure provides a chip apparatus, including a processor, configured to invoke a computer program or computer instructions in a memory, to enable the processor to perform any one of the implementations according to the first aspect to the fourth aspect.

Optionally, the processor is coupled to the memory through an interface.

An eleventh aspect of this disclosure, a communication system is provided. The communication system includes a first communication apparatus and a second communication apparatus. The first communication apparatus is configured to perform the method shown in the first aspect, and the second communication apparatus is configured to perform the method shown in the second aspect; or the first communication apparatus is configured to perform the method shown in the third aspect, and the second communication apparatus is configured to perform the method shown in the fourth aspect.

A twelfth aspect of this disclosure provides a communication apparatus. The communication apparatus includes a logic circuit and an input/output interface. The logic circuit is configured to perform the processing operation according to the first aspect, and the input/output interface is configured to perform the receiving/sending operation according to the first aspect. Alternatively, the logic circuit is configured to perform the processing operation according to the second aspect, and the input/output interface is configured to perform the receiving/sending operation according to the second aspect. Alternatively, the logic circuit is configured to perform the processing operation according to the third aspect, and the input/output interface is configured to perform the receiving/sending operation according to the third aspect. Alternatively, the logic circuit is configured to perform the processing operation according to the fourth aspect, and the input/output interface is configured to perform the receiving/sending operation according to the fourth aspect.

It can be learned from the technical solutions that the first communication apparatus determines the 1^{st}-stage information and the 2^{nd}-stage information. The 1^{st}-stage information is transmitted on the control channel and/or the shared channel. The 2^{nd}-stage information is transmitted on the shared channel. The 2^{nd}-stage information is generated based on the encoding scheme and/or the segmentation scheme that are/is determined according to the first rule. The 1^{st}-stage information is for decoding the 2^{nd}-stage information, and the 1^{st}-stage information and the 2^{nd}-stage information are for a same service. The first communication apparatus sends the 1^{st}-stage information and the 2^{nd}-stage information. It can be learned that the 2^{nd}-stage information is generated based on the encoding scheme and/or the segmentation scheme that are/is determined according to the first rule, thereby transmitting the 2^{nd}-stage information. This helps improve encoding performance of the 2^{nd}-stage information, and compensates for not supporting segmenting the 2^{nd}-stage information in a current communication protocol. The transmission manner of the 2^{nd}-stage information can adapt to different service scenarios of non-conventional communication information, thereby flexibly sending the 2^{nd}-stage information.

### BRIEF DESCRIPTION OF DRAWINGS

FIG. 1 is a diagram of a communication system according to an embodiment of this disclosure;

FIG. 2 is a schematic flowchart of communication between a first communication apparatus and a second communication apparatus according to an embodiment of this disclosure;

FIG. 3 is a diagram of polar code encoding according to an embodiment of this disclosure;

FIG. 4 is a diagram of an embodiment of an information sending method and an information receiving method according to an embodiment of this disclosure;

FIG. 5 is a diagram of another embodiment of an information sending method and an information receiving method according to an embodiment of this disclosure;

FIG. 6 is a diagram of a structure of a first communication apparatus according to an embodiment of this disclosure;

FIG. 7 is a diagram of a structure of a second communication apparatus according to an embodiment of this disclosure;

FIG. 8 is a diagram of a structure of a second communication apparatus according to an embodiment of this disclosure;

FIG. 9 is a diagram of a structure of a communication apparatus according to an embodiment of this disclosure;

FIG. 10 is a diagram of a structure of a terminal device according to an embodiment of this disclosure; and

FIG. 11 is a diagram of a structure of a network device according to an embodiment of this disclosure.

### DESCRIPTION OF EMBODIMENTS

Embodiments of this disclosure provide an information sending method, an information receiving method, and a related apparatus for a first communication apparatus to send 1^{st}-stage information and 2^{nd}-stage information, to transmit the 2^{nd}-stage information. The 2^{nd}-stage information is generated based on an encoding scheme and/or a segmentation scheme that are/is determined according to a first rule. This helps improve encoding performance of the 2^{nd}-stage information and compensates for not supporting segmenting the 2^{nd}-stage information in a current communication protocol. The transmission manner of the 2^{nd}-stage information can adapt to different service scenarios of non-conventional communication information, thereby flexibly sending the 2^{nd}-stage information.

The following clearly and completely describes the technical solutions in embodiments of this disclosure with reference to the accompanying drawings in embodiments of this disclosure. It is clear that the described embodiments are merely a part but not all of embodiments of this disclosure. All other embodiments obtained by a person skilled in the art based on embodiments of this disclosure without creative efforts shall fall within the protection scope of this disclosure.

Reference to “an embodiment”, “some embodiments”, or the like described in this disclosure indicates that one or more embodiments of this disclosure include a specific feature, structure, or characteristic described with reference to embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise emphasized in another manner. The terms “include”, “have”, and their variants all mean “include but are not limited to”, unless otherwise emphasized in another manner.

In descriptions of this disclosure, unless otherwise specified, “/” means “or”. For example, A/B may indicate A or B. A term “and/or” in this specification describes only an association relationship between associated objects and indicates that there may be three relationships. For example, A and/or B may represent the following three cases: only A exists, both A and B exist, and only B exists. In addition, “at least one” means one or more, and “a plurality of” means two or more. “At least one of the following items (pieces)” or a similar expression thereof refers to any combination of these items, including any combination of singular items (pieces) or plural items (pieces). For example, at least one item (piece) of a, b, or c may indicate a, b, c, a and b, a and c, b and c, or a, b, and c, a, b, and c each may be singular or plural.

The technical solutions of this disclosure may be applied to a cellular communication system related to the 3rd Generation Partnership Project (3GPP), for example, a 4th generation (4G) communication system, a 5th generation (5G) communication system, or a communication system after the 5th generation communication system, for example, a 6th generation communication system. For example, the 4th generation communication system may include a Long-Term Evolution (LTE) communication system. The 5th generation communication system may include a New Radio (NR) communication system. The technical solutions of this disclosure may also be applied to a WI-FI system, a communication system that supports convergence of a plurality of wireless technologies, a device-to-device (D2D) system, a vehicle-to-everything (V2X) communication system, a satellite communication system, and the like. The wireless communication system in this disclosure further includes but is not limited to a narrowband Internet of things (NB-IoT) system, a Global System for Mobile Communications (GSM), an Enhanced Data Rate for GSM Evolution (EDGE) system, a wideband code-division multiple access (WCDMA) system, a Code-Division Multiple Access 2000 (CDMA2000) system, or a Time Division-Synchronization Code Division Multiple Access (TD-SCDMA) system.

The technical solutions provided in this disclosure are applicable to a communication system including the first communication apparatus and a second communication apparatus. The 1^{st}-stage information and the 2^{nd}-stage information are transmitted between the first communication apparatus and the second communication apparatus. For the 1^{st}-stage information and the 2^{nd}-stage information, refer to related descriptions in the following embodiments.

In a possible implementation, the first communication apparatus is a terminal device, or a chip, a chip system, or a processor in a terminal device, or a logical module, software, or the like that implements a part or all of functions of a terminal device. The second communication apparatus is a network device, or a chip, a chip system, or a processor in a network device, or a logical module, software, or the like that implements a part or all of functions of a network device.

In another possible implementation, the first communication apparatus is a network device, or a chip, a chip system, or a processor in a network device, or a logical module, software, or the like that implements a part or all of functions of a network device. The second communication apparatus is a terminal device, or a chip, a chip system, or a processor in a terminal device, or a logical module, software, or the like that implements a part or all of functions of a terminal device.

In still another possible implementation, the first communication apparatus is a first terminal device, or a chip, a chip system, or a processor in a first terminal device, or a logical module, software, or the like that implements a part or all of functions of a first terminal device. The second communication apparatus is a second terminal device, or a chip, a chip system, or a processor in a second terminal device, or a logical module, software, or the like that implements a part or all of functions of a second terminal device.

The following describes a terminal device and a network device in this disclosure.

The terminal device may be a device that provides voice or data connectivity for a user. The terminal device is also referred to as user equipment (UE), or may be referred to as a mobile station, a subscriber unit, a station, terminal equipment (TE), customer premise equipment (CPE), a mobile terminal (MT), or the like. For example, the terminal device is a device that includes a wireless communication function (providing voice/data connectivity for the user), for example, a handheld device having a wireless connection function, a vehicle-mounted device, or a machine-type communication (MTC) terminal.

Currently, the terminal device may include: a mobile phone, a cellular phone, CPE, an integrated access backhaul (IAB) small cell, a tablet computer (pad), a notebook computer, a personal digital assistant (PDA), a wireless modem (modem), a cordless phone, a palmtop computer, a mobile internet device (MID), a wireless local loop (WLL) station, a wearable device, a computing device, a virtual reality (VR) device, an augmented reality (AR) device, an Internet of things (IoT) device, a wireless terminal in industrial control, a wireless terminal in self driving (for example, a drone and a vehicle), a wireless terminal in remote medical surgery, a wireless terminal in a smart grid, a wireless terminal in transportation safety, a wireless terminal in a smart city, a terminal device and a vehicle in intelligent transportation, a household device in a smart home, a power metering instrument in a smart grid, a voltage monitoring instrument, an environmental monitoring instrument, a video surveillance instrument in an intelligent security network, a cash register, or a wireless terminal in a smart home. For example, the wireless terminal in self driving may be an uncrewed aerial vehicle, a helicopter, or an airplane. For example, a wireless terminal in vehicle-to-everything may be a vehicle-mounted device, vehicle equipment, a vehicle-mounted module, a vehicle, or a ship. The wireless terminal in industrial control may be a camera, a robot, a robotic arm, or the like. The wireless terminal in the smart home may be a television, an air conditioner, a sweeper, a speaker, a set-top box, or the like. The terminal device may be a mobile terminal or a non-mobile terminal, or may be an airborne terminal, a handheld terminal, or the like.

It should be noted that the terminal device may be a device or an apparatus with a chip, a device or an apparatus integrated with a circuit, or a chip, a chip system, a module, or a control unit in the foregoing device or apparatus. This is not limited in this disclosure. It should be noted that, in this disclosure, reference to the terminal device may mean the terminal device itself, or may mean a chip, a functional module, an integrated circuit, or the like that is in the terminal device and that completes the method provided in this disclosure. This is not limited in this disclosure.

The network device supports access by the terminal device and provides functions such as a communication service for the terminal device. For example, the network device may be a terrestrial device such as a base station in a 6G communication system, an evolved NodeB (eNB) in a 4G access technology communication system, a next generation NodeB (gNB) in a 5G access technology communication system, a transmission reception point (TRP), a relay node, an access point (AP), or a gateway. For example, the gateway is used for communication between the terminal device and a core network, for example, a terrestrial station. Alternatively, the network device may be a non-terrestrial device: a satellite base station, a satellite terrestrial station, or a high-altitude base station. For example, the network device may be a device, such as a hot air balloon, that may provide a wireless access function for the terminal device, a low-orbit satellite, a medium-orbit satellite, or a high-orbit satellite, or may be an unmanned aerial vehicle or an airplane, or may be a mobile switching center or a device that undertakes a base station function in D2D, V2X, or machine-to-machine (M2M) communication.

It should be noted that the network device may be a device or an apparatus with a chip, a device or an apparatus integrated with a circuit, or a chip, a chip system, a module, or a control unit in the foregoing device or apparatus. This is not limited in this disclosure. It should be noted that, in this disclosure, reference to the network device may mean the network device itself, or may mean a chip, a functional module, an integrated circuit, or the like that is in the network device and that completes the method provided in this disclosure. This is not limited in this disclosure.

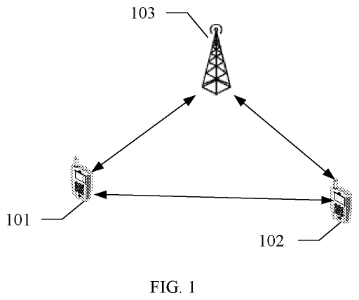

FIG. 1 is a diagram of a communication system according to an embodiment of this disclosure. As shown in FIG. 1, a first communication apparatus is a terminal device 101, and a second communication apparatus is a base station 103. The technical solutions of this disclosure may be performed between the terminal device 101 and the base station 103. Alternatively, the first communication apparatus is a terminal device 101, and the second communication apparatus is a terminal device 102. The technical solutions of this disclosure may be performed between the terminal device 101 and the terminal device 102.

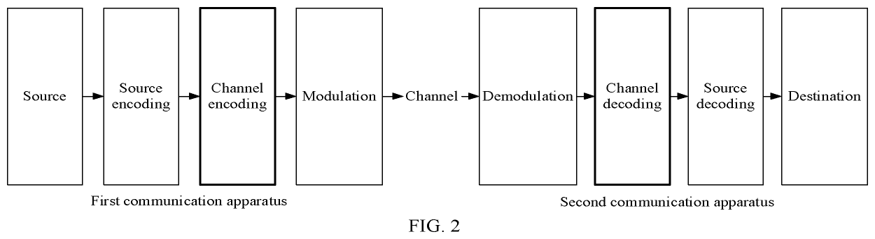

The first communication apparatus may encode 1^{st}-stage information and 2^{nd}-stage information, and then send encoded 1^{st}-stage information and 2^{nd}-stage information to the second communication apparatus. Therefore, it can be understood that the first communication apparatus is used as an encoding apparatus, and the second communication apparatus is used as a decoding apparatus. As shown in FIG. 2, a first communication apparatus is responsible for performing channel encoding on bits generated by a source, and then obtaining a modulated symbol through modulation. The first communication apparatus sends the modulated symbol to a second communication apparatus through a channel. The second communication apparatus demodulates the received modulated symbol, and then performs channel decoding, to restore the bits generated by the source.

The following describes polar code encoding and polar code decoding.

Polar code encoding is an only known channel encoding scheme that can be strictly proved to reach a channel capacity, and features high performance, low complexity, flexible matching manners, and the like. Currently, polar code encoding has been determined by the 3GPP as a control channel encoding scheme in an enhanced mobile broadband (eMBB) scenario.

### 1. Polar Code Encoding Scheme

A polar code encoding matrix G may be obtained by performing n Kronecker product operations based on a standard polarization kernel

$$F = [ \begin{matrix}1 & 0 \\ 1 & 1\end{matrix} ] .$$

For example, when n=2, a polar code encoding matrix

$$G = {F}^{⊗ n} = [ \begin{matrix}1 & 1 & 0 & 0 \\ 1 & 0 & 1 & 0 \\ 1 & 0 & 1 & 0 \\ 1 & 1 & 1 & 1\end{matrix} ]$$

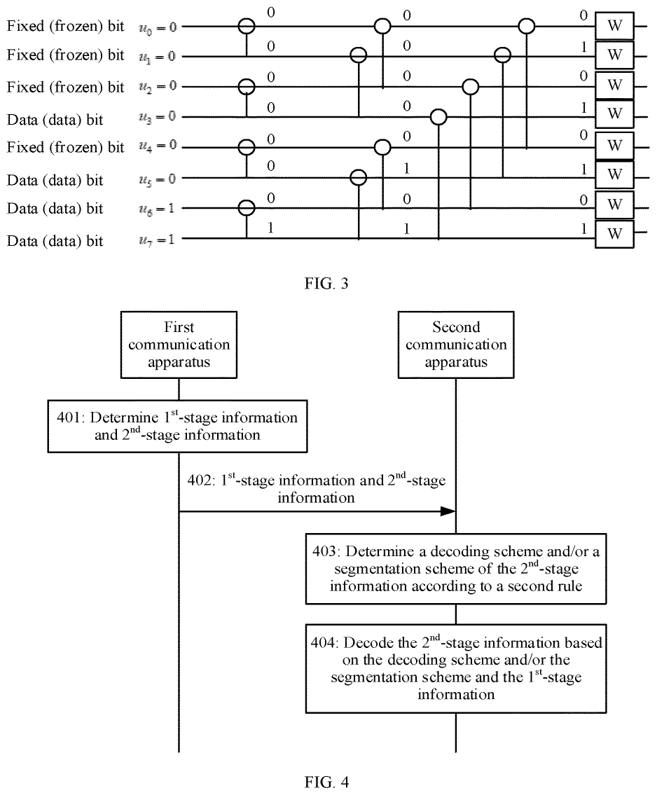

with a code length N=4 can be obtained. FIG. 3 is a diagram of typical polar code encoding. To-be-encoded bits are sorted based on reliability of the to-be-encoded bits, and are divided into fixed (frozen) bits and information (data) bits. Generally, a bit with higher reliability is set as an information bit, and a bit with lower reliability is set as a fixed bit. A value of the fixed bit is usually set to 0, and is known to both a transmitting end and a receiving end during actual transmission. As shown in FIG. 1, u₇, u₆, u₅, and u₃ are four bits with highest reliability. Therefore, u₇, u₆, u₅, and u₃ are all set as information bits. u₄, u₂, u₁, and u₀ are four bits with lowest reliability. Therefore, u₄, u₂, u₁, and u₀ are all set as fixed bits.

### 2. Polar Code Decoding Scheme

In recent years, as polar code is included in a 5G standard, research on polar code decoding becomes a hot topic in the communication field. Current mainstream polar code decoding methods may be classified into two types based on polar code decoding time sequences: polar code sequential decoding and polar code non-sequential decoding. Polar code sequential decoding means that a decoder performs bit-wise decoding based on a natural time sequence of a polar code design. Polar code non-sequential decoding means that a decoder outputs a decoding result in parallel based on another polar code structure (for example, a Tanner graph or a Trellis graph).

Currently, main polar code sequential decoding algorithms include successive cancellation (SC) decoding, successive cancellation list (SCL) decoding, successive cancellation stack (SCS) decoding, and cyclic redundancy check-aided successive cancellation list (CA-SCL) decoding. Non-sequential decoding algorithms include belief propagation (BP) decoding and the like. Decoding performance of SC decoding is the worst, but a decoding delay is mitigated. Decoding performance of BP decoding is slightly better than that of SC decoding. Decoding performance of SCL decoding is greatly improved compared with the former. CA-SCL decoding with cyclic redundancy check (CRC) can implement better performance of the polar code than that of LDPC and turbo code. Therefore, currently, SCL decoding and CA-SCL decoding are mainly used in an actual system.

An advantage of polar code sequential decoding is that polar code sequential decoding is compatible with a polar code design, and theoretical analysis is convenient. A disadvantage is that because of the bit-wise output feature of polar code sequential decoding, a decoding delay is high, and polar code sequential decoding is not suitable for a communication system that has a high requirement on real-time performance. Instead, through polar code non-sequential decoding, a plurality of bits can be output at a time, a decoding delay is low. However, because polar code non-sequential decoding does not fully match the polar code design, a specific decoding performance loss is caused. However, this loss can be minimized based on a reasonable design.

The following describes LDPC encoding and decoding.

LDPC is a channel encoding scheme that is very close to a Shannon line, featuring good performance, low complexity, and the like. Currently, the 3GPP has determined that the LDPC is a 5G data channel encoding scheme.

The LDPC encoding scheme is implemented by generating a matrix. Mainstream LDPC has a quasi-cyclic (QC) structure. A shift amount of each block is set to avoid a bad structure like a short cycle and to improve a code distance. Currently, LDPC decoding algorithms mainly include a minimum sum (MS) decoding algorithm and a BP decoding algorithm. Decoding performance of the BP decoding algorithm is better. However, the BP decoding algorithm has a large amount of information storage, and calculation of m_{c→v} is complex. This is not conducive to hardware implementation. Therefore, an offset minimum sum (Offset-MS) decoding algorithm and a normalized minimum sum (Normalized-MS) decoding algorithm are currently used in an actual communication system. LDPC that is actually used is a cyclic shift matrix obtained by extending 1 in a base graph BG. A BG model of QC-LDPC is BG=(X, Y, F), where X corresponds to a variable, Y corresponds to a check equation, and F is an edge connection relationship thereof. A Tanner graph, that is, a bipartite graph G=(V, C, E), is obtained after QC expansion with an expansion factor of Z_{c}, where V is a variable node, C is a check node, E is an edge connection relationship thereof. A corresponding number of columns in a check matrix is N=|V|=Z_{c}|X|, a number of rows in the check matrix is M=|C|=Z_{c}|Y|, and a number of non-zero elements in the check matrix is |E|=Z|F|.

An information bit range supported by a 5G data channel is 1 to 8448. The standard describes two check matrices: BG₁ and BG₂. A same base graph needs to use different lifting sizes to adapt to rate matching with different code lengths. Therefore, a lifting size list and a shifting value list need to be stored, and rate matching needs to be performed based on the lifting size list and the shifting value list.

Stored shifting value content of the 5G LDPC includes a lifting size list and a shifting value list that is in a one-to-one correspondence with rows of the lifting size list. The lifting size list may be represented as Table 1:

TABLE 1

| Set | |
|---|---|
| index | |
| (i_{LS}) | Set of lifting size (Z) |
| 0 | {2, 4, 8, 16, 32, 64, 128, 256} |
| 1 | {3, 6, 12, 24, 48, 96, 192, 384} |
| 2 | {5, 10, 20, 40, 80, 160, 320} |
| 3 | {7, 14, 28, 56, 112, 224} |
| 4 | {9, 18, 36, 72, 144, 288} |
| 5 | {11, 22, 44, 88, 176, 352} |
| 6 | {13, 26, 52, 104, 208} |
| 7 | {15, 30, 60, 120, 240} |

A j^{th} row of the lifting size list is aⱼ×2^{k}^{ⱼ}, where aⱼ∈{2, 3, 5, 7, 9, 11, 13, 15}, and max (kⱼ)∈{7, 7, 6, 5, 5, 5, 4, 4}. Row indexes of the lifting size are in a one-to-one correspondence with column indexes of the shifting value, that is, lifting sizes in each row of the lifting size list correspond to a group of shifting values. During rate matching, a lifting size is first determined, and then a corresponding shifting value is selected to construct a check matrix.

As shown in Table 2, each group of lifting sizes of the 5G LDPC share a same group of shifting values, and each edge of the BG corresponds to one shifting value. When a shifting value is needed, the value is read from the table, and then the value is used after a modulo operation is performed.

TABLE 2

| H_{BG} | | V_{i, j} | | | | | | | |
|---|---|---|---|---|---|---|---|---|---|
| Row | Column | Set index (i_{LS}) | | | | | | | |
| index i | index j | 0 | 1 | 2 | 3 | 4 | 5 | 6 | 7 |
| 0 | 0 | 250 | 307 | 73 | 223 | 211 | 294 | 0 | 135 |
| | 1 | 69 | 19 | 15 | 16 | 198 | 118 | 0 | 227 |
| | 2 | 226 | 50 | 103 | 94 | 188 | 167 | 0 | 126 |
| | 3 | 159 | 369 | 49 | 91 | 186 | 330 | 0 | 134 |
| | 5 | 100 | 181 | 240 | 74 | 219 | 207 | 0 | 84 |
| | 6 | 10 | 216 | 39 | 10 | 4 | 165 | 0 | 83 |
| | 9 | 59 | 317 | 15 | 0 | 29 | 243 | 0 | 53 |
| | 10 | 229 | 288 | 162 | 205 | 144 | 250 | 0 | 225 |
| | 11 | 110 | 109 | 215 | 216 | 116 | 1 | 0 | 205 |
| | 12 | 191 | 17 | 164 | 21 | 216 | 339 | 0 | 128 |
| | 13 | 9 | 357 | 133 | 215 | 115 | 201 | 0 | 75 |
| | 15 | 195 | 215 | 298 | 14 | 233 | 53 | 0 | 135 |
| | 16 | 23 | 106 | 110 | 70 | 144 | 347 | 0 | 217 |
| | 18 | 190 | 242 | 113 | 141 | 95 | 304 | 0 | 220 |
| | 19 | 35 | 180 | 16 | 198 | 216 | 167 | 0 | 90 |
| | 20 | 239 | 330 | 189 | 104 | 73 | 47 | 0 | 105 |
| | 21 | 31 | 346 | 32 | 81 | 261 | 188 | 0 | 137 |
| | 22 | 1 | 1 | 1 | 1 | 1 | 1 | 0 | 1 |
| | 23 | 0 | 0 | 0 | 0 | 0 | 0 | 0 | 0 |

To support AI-based communication such as extended reality (XR), integrated sensing and communication, and AI-for-Net, a large amount of non-conventional communication information may be generated in the future. The non-conventional communication information is transmitted only at a layer 1 and is not reported to a higher layer with communication information. The non-conventional communication information may include 2^{nd}-stage control information. The 2^{nd}-stage control information is similar to 2^{nd}-stage control information transmitted on a physical uplink control channel (PUCCH) and a physical downlink control channel (PDCCH), but a length of the 2^{nd}-stage control information is greater than a length of the 1^{st}-stage control information. How to transmit the 2^{nd}-stage control information, for example, how to segment and encode 2^{nd}-stage control information of different lengths, is an issue worth considering.

In this disclosure, in a scenario of transmitting non-conventional communication information, a service or a service type may be a service, a communication service, or a service user service. The service type may also be referred to as a service scenario, a communication service type, or a user scenario. For example, in the scenario of transmitting non-conventional communication information, the service type may be an XR service, an AR service, a VR service, a sensing service, an integrated sensing and communication service, an artificial intelligence service, and/or a T-MIMO service. The non-conventional communication information includes service information of the service, and a length of the service information is usually less than a length of control information transmitted on a PUCCH and/or a PDCCH, but has a length similar to that of communication information transmitted on a PUSCH and/or a PDSCH. However, the service information may be transmitted only at the L1, and not reported to a higher layer along with the communication information. The service information may have a low requirement on reliability, and the service information may not carry specific user data.

This disclosure provides an information sending method, an information receiving method, and a related apparatus, to implement transmission of 2^{nd}-stage information. For details, refer to related descriptions in the following embodiments.

FIG. 4 is a diagram of an embodiment of an information sending method and an information receiving method according to an embodiment of this disclosure. Refer to FIG. 4. The method includes the following steps.

401: The first communication apparatus determines 1^{st}-stage information and 2^{nd}-stage information that correspond to a same service type.

The 1^{st}-stage information is transmitted on a control channel and/or a shared channel. The 2^{nd}-stage information is transmitted on the shared channel.

In a possible implementation, the first communication apparatus is a network device, and the second communication apparatus is a terminal device. The 1^{st}-stage information is transmitted on a PDCCH and/or a PDSCH. The 2^{nd}-stage information is transmitted on the physical downlink shared channel.

In another possible implementation, the first communication apparatus is a terminal device, and the second communication apparatus is a network device. The 1^{st}-stage information is transmitted on a PUCCH and/or a PUSCH. The 2^{nd}-stage information is transmitted on the physical uplink shared channel.

In still another possible implementation, the first communication apparatus is a first terminal device, and the second communication apparatus is a second terminal device. The 1^{st}-stage information is on a physical sidelink control channel (PSCCH) and/or a physical sidelink shared channel (PSSCH). The 2^{nd}-stage information is transmitted on the physical sidelink shared channel.

It should be noted that the 2^{nd}-stage information is transmitted on the shared channel in the foregoing several scenarios. Optionally, the 2^{nd}-stage information may alternatively be transmitted on a newly defined shared channel. For example, a corresponding shared channel is defined based on a type of service information carried in the 2^{nd}-stage information, and the 2^{nd}-stage information is transmitted on the newly defined shared channel. For example, if the 2^{nd}-stage information carries sensing-related information, the newly defined shared channel may be referred to as a physical sensing downlink shared channel (PSDSCH) or a physical sensing uplink shared channel (PSUSCH), and the 2^{nd}-stage information may be carried on the PSDSCH or the PSUSCH. For another example, the 2^{nd}-stage information carries AI training data, and the newly defined shared channel may be referred to as a physical artificial intelligence downlink shared channel (PADSCH) or a physical artificial intelligence uplink shared channel (PAUSCH).

Optionally, the 1^{st}-stage information includes 1^{st}-stage control information. For example, the first communication apparatus is a terminal device, and the second communication apparatus is a network device. The 1^{st}-stage control information is 1^{st}-stage UCI. For another example, the first communication apparatus is a network device, and the second communication apparatus is a terminal device. The 1^{st}-stage control information is 1^{st}-stage DCI. For another example, the first communication apparatus is a first terminal device, and the second communication apparatus is a second terminal device. The 1^{st}-stage control information is 1^{st}-stage SCI.

Optionally, the 2^{nd}-stage information includes 2^{nd}-stage control information. For example, the first communication apparatus is a terminal device, and the second communication apparatus is a network device. The 2^{nd}-stage control information is 2^{nd}-stage UCI. For another example, the first communication apparatus is a network device, and the second communication apparatus is a terminal device. The 2^{nd}-stage control information is 2^{nd}-stage DCI. For another example, the first communication apparatus is a first terminal device, and the second communication apparatus is a second terminal device. The 2^{nd}-stage control information is 2^{nd}-stage SCI.

Optionally, the name of the 2^{nd}-stage information may also be a newly defined name. For example, the 2^{nd}-stage information carries sensing-related information, and the 2^{nd}-stage information may be referred to as 2^{nd}-stage uplink sensing information (2^{nd}-stage USI) or 2^{nd}-stage downlink sensing information (2^{nd}-stage DSI). For another example, the 2^{nd}-stage information is carried in AI training data, and the 2^{nd}-stage information may be referred to as 2^{nd}-stage uplink artificial intelligence information (2^{nd}-stage UAI) or 2^{nd}-stage downlink artificial intelligence information (2^{nd}-stage DAI).

The 1^{st}-stage information is for decoding the 2^{nd}-stage information. Optionally, the 1-stage information includes information about a resource occupied for decoding the 2^{nd}-stage information. In other words, the second communication apparatus may parse the 1^{st}-stage information, to determine a time-frequency resource location occupied by the 2^{nd}-stage information and the like. The second communication apparatus may receive the 2^{nd}-stage information at the time-frequency resource location. The following shows some possible fields of the information about the resource occupied for decoding the 2^{nd}-stage information.

Optionally, the 1^{st}-stage information includes at least one of the following: a carrier indicator field, a bandwidth part indicator field, a time domain resource assignment field, a frequency domain resource assignment field, a VRB-to-PRB mapping field, a PRB size indicator field, a reserved resource field, a zero-power CSI-RS trigger indicator field, a channel access type and cyclic extension field, a dormancy indication field, an invalid symbol pattern indicator field, or a scheduling offset indicator field.

The carrier indicator field indicates a component carrier of the DCI when cross-carrier scheduling exists. The carrier indicator field occupies a maximum of 3 bits. The bandwidth part indicator field indicates resource assignment in time domain. The bandwidth part indicator field occupies a maximum of 6 bits.

The time domain resource assignment field indicates resource assignment in time domain. The time domain resource assignment field occupies a maximum of 6 bits. The frequency domain resource assignment field indicates a resource block assigned on one component carrier. A number of bits occupied by the frequency domain resource assignment field is determined based on a bandwidth part size and a resource allocation type.

The VRB-to-PRB mapping field indicates interleaved or non-interleaved VRB-to-PRB mapping, and the VRB-to-PRB mapping field occupies a maximum of 1 bit.

The PRB size indicator field indicates a PDSCH bundling size. The PRB size indicator field occupies a maximum of 1 bit.

The reserved resource field indicates that a reserved resource is used in data transmission. The reserved resource field occupies a maximum of 2 bits.

The zero-power CSI-RS trigger indicator field indicates a resource element that needs to be skipped by the terminal device during resource mapping and rate matching. The zero-power CSI-RS trigger indicator field occupies a maximum of 2 bits.

The channel access type and cyclic extension field indicates a to-be-used channel access process in an unlicensed spectrum. The channel access type and cyclic extension field occupies a maximum of 1 bit.

The dormancy indication field indicates whether to enter dormancy to reduce power consumption. The dormancy indication field occupies a maximum of 5 bits.

The invalid symbol pattern indicator field is for enhancing ultra-reliable low-latency communications (URLLC) and determining whether to use an invalid symbol pattern. The invalid symbol pattern indicator field occupies a maximum of 1 bit.

The scheduling offset indicator field is for controlling cross-slot scheduling for power saving. The scheduling offset indicator field occupies a maximum of 1 bit. The channel access type and cyclic extension field occupies a maximum of 2 bits.

Optionally, the 1^{st}-stage information does not include at least one of the following: a shared channel indicator, a new data indicator, a redundancy version, a priority indicator, a HARQ process number, a downlink assignment index, PDSCH-to-HARQ feedback timing, a code block group transmission indicator, code block group flush information, a PDSCH group index, a number of requested PDSCH groups, a one-shot HARQ, a new feedback indicator, an antenna port, a transmission configuration indicator TCI, a sounding reference signal request, DMRS sequence initialization, or power control.

The shared channel indicator indicates whether a current shared channel carries the 2^{nd}-stage information. The new data indicator indicates whether the shared channel carries initially transmitted data or retransmitted data. The redundancy version indicates a redundancy version corresponding to the retransmitted data. The priority indicator indicates a HARQ acknowledgment priority. The HARQ process number indicates which HARQ process should be used by the terminal device for soft-combining during this transmission. The downlink assignment index indicates HARQ codebook information when the control information needs to be transmitted on a data channel.

The PDSCH-to-HARQ feedback timing indicates when HARQ feedback is sent relative to PDSCH transmission. The code block group transmission indicator indicates code block group retransmission information. The code block group flush information indicates soft buffer flushing. The PDSCH group index indicates a PDSCH group in the unlicensed spectrum and controls a HARQ codebook. The number of requested PDSCH groups indicates, in the unlicensed spectrum, whether HARQ feedback includes only a current PDSCH group or may include another PDSCH group.

The one-shot HARQ is for requesting to activate one piece of HARQ feedback for HARQ processes of all carriers and PDSCH groups in the unlicensed spectrum. The new feedback indicator indicates whether a receiving end receives HARQ feedback in the unlicensed spectrum. The antenna port is an antenna port used for data transmission and an antenna port used by another terminal device. The transmission configuration indicator indicates a quasi co-location (QCL) relationship of downlink transmission. The SRS request indicates an SRS transmission request. DMRS sequence initialization is for selecting two preconfigured initial DMRS sequence values. Power control is for notifying the terminal device to adjust transmit power of the control information.

In this way, the 1^{st}-stage information is simplified, and the 1^{st}-stage information is encoded without segmentation. A payload size of the 1^{st}-stage information is further reduced, and blind detection complexity of the second communication apparatus is reduced.

Optionally, a length of the 1^{st}-stage information is less than or equal to a sixth length. For example, the sixth length is 70.

Optionally, the 2^{nd}-stage information includes at least one of the following: T-MIMO CSI, sensing-related information, artificial intelligence-related information, the shared channel indicator, the new data indicator, the redundancy version, the priority indicator, the HARQ process number, the downlink assignment index, the PDSCH-to-HARQ feedback timing, the code block group transmission indicator, the code block group flush information, the PDSCH group index, the number of requested PDSCH groups, the one-shot HARQ, the new feedback indicator, the antenna port, the transmission configuration indicator TCI, the sounding reference signal request, the DMRS sequence initialization, or the power control. The T-MIMO CSI includes T1 bit MIMO channel state information. The sensing-related information is for providing sensing-related data. The artificial intelligence-related information includes artificial intelligence training information and/or artificial intelligence inference information. For functions of some other fields, refer to the foregoing related descriptions. It can be learned that a field in original 1^{st}-stage information is moved to the 2^{nd}-stage information, to simplify the 1^{st}-stage information.

The 1^{st}-stage information and the 2^{nd}-stage information correspond to a same service type, that is, the 1^{st}-stage information and the 2^{nd}-stage information are for a same service. In other words, the first communication apparatus sends the 1^{st}-stage information and the 2^{nd}-stage information for the same service. In this way, the second communication apparatus parses the 1^{st}-stage information, to determine a time-frequency resource on which the 2^{nd}-stage information is located. For the service type, refer to the foregoing related descriptions. Then, the second communication apparatus may parse the 2^{nd}-stage information, to obtain related data of the service. For example, for some specific communication scenarios, the name of the 1^{st}-stage information and the name of the 2^{nd}-stage information may indicate that the 1^{st}-stage information and the 2^{nd}-stage information are for the same service. For example, in a sidelink (SL) scenario, the 1^{st}-stage information is 1^{st}-stage SCI, and the 2^{nd}-stage information is 2^{nd}-stage SCI. For another example, the 1^{st}-stage information includes a second field, and the second field indicates the service. For example, the 2^{nd}-stage information carries sensing-related information, the 1^{st}-stage information includes a second field, and the second field indicates a sensing service. It can be learned that both the 1^{st}-stage information and the 2^{nd}-stage information are sent for the sensing service.

Optionally, the 1^{st}-stage information is carried in at least one of the following: a scheduling request (SR), a hybrid automatic repeat request acknowledgment (HARQ-ACK), or channel state information (CSI). The 2^{nd}-stage information is carried in an intra-radio access network (intra RAN) and/or control information with a large payload size in the T-MIMO CSI.

The 2^{nd}-stage information is generated based on an encoding scheme and/or a segmentation scheme that are/is determined according to a first rule.

The following describes some possible implementations of the first rule.

1. The first rule includes: segmenting the 2^{nd}-stage information based on a first length, and encoding segmented 2^{nd}-stage information based on a polar code encoding scheme. The first length is 2ⁿ, and n is a positive integer.

Optionally, the first length is less than 1024, that is, less than a maximum encoding length of 1024 supported by a polar encoding scheme. For example, the first length is 32, 64, 128, 256, or 512. In other words, the first length is 2ⁿ, and n is equal to 5, 6, 7, 8, or 9.

In this implementation, the first communication apparatus segments the 2^{nd}-stage information based on the first length by default, so that a length of each segment of the segmented 2^{nd}-stage information is the first length. Certainly, a length of a last segment of the segmented 2^{nd}-stage information may be less than or equal to the first length. For example, if a length of the 2^{nd}-stage information is 2250, and the first length is 512, it can be learned that the first communication apparatus obtains five segments by segmenting the 2^{nd}-stage information. Lengths of four segments each are 512, and a length of the other segment is 202. Then, the first communication apparatus encodes the segmented 2^{nd}-stage information based on the polar code encoding scheme by default.

2. The first rule includes: segmenting the 2^{nd}-stage information based on a second length, and encoding segmented 2^{nd}-stage information based on an LDPC encoding scheme.

Optionally, the second length is determined based on a payload size and a channel coding rate of the 2^{nd}-stage information. Optionally, the 1^{st}-stage information includes information indicating the channel coding rate of the 2^{nd}-stage information.

For example, in correspondence to the payload size of the 2^{nd}-stage information less than or equal to 292, or in correspondence to the payload size of the 2^{nd}-stage information less than or equal to 3824 and the channel coding rate of the 2^{nd}-stage information less than or equal to 0.25, the 2^{nd}-stage information is segmented based on the second length of 3840, and LDPC encoding is performed on the segmented 2^{nd}-stage information based on a BG 2; or in correspondence to the payload size of the 2^{nd}-stage information greater than 292, or in correspondence to the payload size of the 2^{nd}-stage information greater than 3824 and the channel coding rate of the 2^{nd}-stage information greater than 0.25, the 2^{nd}-stage information is segmented based on the second length of 8448, and LDPC encoding is performed on the segmented 2^{nd}-stage information based on a BG 1.

The first communication apparatus segments the 2^{nd}-stage information based on the second length of 3840, that is, a length of each segment of the segmented 2^{nd}-stage information is 3840. Certainly, a length of a last segment of the segmented 2^{nd}-stage information may be less than or equal to 3840. The first communication apparatus segments the 2^{nd}-stage information based on the second length of 8448, that is, a length of each segment of the segmented 2^{nd}-stage information is 8448. Certainly, a length of a last segment of the segmented 2^{nd}-stage information may be less than or equal to 8448.

For the 2^{nd}-stage information whose payload size is less than or equal to 292, or the 2^{nd}-stage information whose payload size is less than or equal to 3824 and the channel coding rate of the 2^{nd}-stage information is less than or equal to 0.25, the first communication apparatus performs LDPC encoding on the segmented 2^{nd}-stage information based on the BG 2. This helps improve error correction performance of the second communication apparatus on the 2^{nd}-stage information. Otherwise, the first communication apparatus performs LDPC encoding on the segmented 2^{nd}-stage information based on the BG 1. This implements high encoding performance, and improves the error correction performance of the second communication apparatus on the 2^{nd}-stage information.

3. The first rule includes: determining the encoding scheme and/or the segmentation scheme of the 2^{nd}-stage information based on a payload size of the 2^{nd}-stage information and a channel coding rate of the 2^{nd}-stage information.

Optionally, in correspondence to the payload size of the 2^{nd}-stage information less than or equal to 384 and the channel coding rate of the 2^{nd}-stage information less than or equal to 0.5, or in correspondence to the payload size of the 2^{nd}-stage information less than or equal to 140, the 2^{nd}-stage information is encoded based on a polar code encoding scheme without segmentation; or in correspondence to the payload size of the 2^{nd}-stage information greater than 384 and the channel coding rate of the 2^{nd}-stage information greater than 0.5, or in correspondence to the payload size of the 2^{nd}-stage information greater than 140, the 2^{nd}-stage information is segmented based on a segment length of 3840, and segmented 2^{nd}-stage information is encoded based on an LDPC encoding scheme.

The first communication apparatus segments the 2^{nd}-stage information based on a segment length of 3840, that is, a length of each segment of the segmented 2^{nd}-stage information is 3840. Certainly, a length of a last segment of the segmented 2^{nd}-stage information may be less than or equal to 3840.

In the communication protocol, the first rule in the implementation 3 may be represented as follows:

if A ≤ 384 and R ≤ 0.5 or A ≤ 140
Use Polar code and no CB segmentation;
else
Use LDPC and CB segmentation according to K_{cb} = 3840;
end if

A is the payload size of the 2^{nd}-stage information, and R is the channel coding rate of the 2^{nd}-stage information. If A≤384 and R≤0.5, or A≤140, the first communication apparatus encodes the 2^{nd}-stage information based on the polar code encoding scheme without segmentation. Otherwise, the first communication apparatus segments the 2^{nd}-stage information based on a segment length of K_{cb}=3840, and encodes the segmented 2^{nd}-stage information based on the LDPC encoding scheme.

It can be learned that, if the payload size of the 2^{nd}-stage information is small, and/or the channel coding rate of the 2^{nd}-stage information is small, the first communication apparatus may encode the 2^{nd}-stage information based on the polar code encoding scheme. If the payload size of the 2^{nd}-stage information is large, and/or the channel coding rate of the 2^{nd}-stage information is large, the first communication apparatus may encode the 2^{nd}-stage information based on the LDPC encoding scheme. This helps improve encoding performance.

4. The first rule includes: determining the encoding scheme and/or the segmentation scheme of the 2^{nd}-stage information based on a length of rate-matched 2^{nd}-stage information, a number of available physical resources, and/or a modulation order.

Optionally, in correspondence to the length of the rate-matched 2^{nd}-stage information less than or equal to a maximum length, a number of segments of the 2^{nd}-stage information is determined based on a maximum encoding length supported by a polar code encoding scheme and the number of available physical resources, the 2^{nd}-stage information is segmented based on the number of segments of the 2^{nd}-stage information, and segmented 2^{nd}-stage information is encoded based on the polar code encoding scheme; or in correspondence to the length of the rate-matched 2^{nd}-stage information greater than the maximum length, a number of segments of the 2^{nd}-stage information is determined based on a maximum encoding length supported by an LDPC encoding scheme and the number of available physical resources, the 2^{nd}-stage information is segmented based on the number of segments of the 2^{nd}-stage information, and segmented 2^{nd}-stage information is encoded based on the LDPC encoding scheme, where the maximum length is determined based on the number of available physical resources and the modulation order.

Optionally, the maximum length is equal to the number of available physical resources multiplied by the modulation order. Optionally, the 1^{st}-stage information carries or indicates the modulation order.

For example, the 2^{nd}-stage information is the 2^{nd}-stage UCI. If the length G^{UC12} of the rate-matched 2^{nd}-stage information is less than or equal to Eₘₐₓ, and the maximum encoding length supported by the polar code encoding scheme is 1024, the first communication apparatus determines the number of segments of the 2^{nd}-stage information based on the maximum encoding length supported by the polar code encoding scheme and the number of available physical resources; and the first communication apparatus segments the 2^{nd}-stage information based on the number of segments of the 2^{nd}-stage information, and encodes the segmented 2^{nd}-stage information based on the polar code encoding scheme. If the length G^{UC12} of the rate-matched 2^{nd}-stage information is greater than Eₘₐₓ, and the maximum encoding length supported by the LDPC encoding scheme is 3840, the first communication apparatus determines the number of segments of the 2^{nd}-stage information based on the maximum encoding length supported by the LDPC encoding scheme and the number of available physical resources; and the first communication apparatus segments the 2^{nd}-stage information based on the number of segments of the 2^{nd}-stage information, and encodes the segmented 2^{nd}-stage information based on the LDPC encoding scheme.

Optionally, the number of available physical resources is Eₜₒₜₐₗ. The maximum encoding length supported by the polar encoding scheme or the maximum encoding length supported by the LDPC encoding scheme is represented as Nₘ. If Eᵣₑₛₜ is less than a first threshold, the number C of segments=C₁. Otherwise, the number C of segments=C₁+1. Eᵣₑₛₜ=Eₜₒₜₐₗ−C₁×Nₘ, C₁=[Eₜₒₜₐₗ/Nₘ]. Optionally, the first threshold is greater than or equal to

$$\frac{1 {N}_{m}}{2} .$$

For example, the first threshold is equal to

$$\frac{9 {N}_{m}}{16} .$$

Eᵣₑₛₜ indicates a number of remaining available physical resources. In other words, if Eᵣₑₛₜ is greater than or equal to half of Nₘ, the number of segments may be increased by one. This helps improve encoding performance.

In the communication protocol, the first rule in the implementation 4 may be represented as follows:

if G^{UCI2} ≤ Eₘₐₓ
Use Polar code and CB segmentation according to Nₘₐₓ = 1024;
else
Use LDPC and CB segmentation according to K_{cb} = 3840;
end if

G^{UC12} is the rate-matched 2^{nd}-stage information, and Eₘₐₓ is the maximum length. Nₘₐₓ is the maximum encoding length supported by the polar code encoding scheme. K_{cb} is the maximum encoding length supported by the LDPC encoding scheme.

5. The 1^{st}-stage information includes first indication information, and the first indication information indicates an encoding scheme used for the 2^{nd}-stage information. The first rule includes: if the first indication information indicates that a polar code encoding scheme is used to encode the 2^{nd}-stage information, encoding the 2^{nd}-stage information without segmentation; or if the first indication information indicates that an LDPC encoding scheme is used to encode the 2^{nd}-stage information, segmenting the 2^{nd}-stage information based on a third length.

Optionally, the first indication information is a first field in the 1^{st}-stage information. For example, the first field is 1 bit, 2 bits, or 3 bits. A length of the first field is not limited in this disclosure.

Optionally, when a value of the first field is 0, it indicates that the 2^{nd}-stage information is encoded based on the polar code encoding scheme; or when a value of the first field is 1, it indicates that the 2^{nd}-stage information is encoded based on the LDPC encoding scheme. Alternatively, when a value of the first field is 0, it indicates that the 2^{nd}-stage information is encoded based on the LDPC encoding scheme; or when a value of the first field is 1, it indicates that the 2^{nd}-stage information is encoded based on the polar code encoding scheme.

For example, the 1^{st}-stage information is 1^{st}-stage DCI, and the 2^{nd}-stage information is 2^{nd}-stage DCI. Physical resource information, channel encoding type information, and segmentation information of the 2^{nd}-stage DCI are all reflected in the 1^{st}-stage DCI. A resource configuration field (for example, time-frequency resource assignment information, a resource reservation period, a DMRS pattern, a 2^{nd}-stage UCI format, a modulation and coding scheme (MCS), a Beta_offset indicator, a number of DMRS ports, and a code type indicator indicating the 2^{nd}-stage DCI are newly added to the 1^{st}-stage DCI. In other words, the first field is the code type indicator, and the code type indicator indicates an encoding scheme used for the 2^{nd}-stage DCI. The Beta_offset indicator is a parameter for calculating a number of resource elements (REs).

In this implementation, if the first indication information indicates that the first communication apparatus encodes the 2^{nd}-stage information based on the polar code encoding scheme, the first communication apparatus encodes the 2^{nd}-stage information without segmentation by default. If the first indication information indicates that the first communication apparatus encodes the 2^{nd}-stage information based on the LDPC encoding scheme, the first communication apparatus segments the 2^{nd}-stage information based on the third length.

Optionally, the third length is 3840 or 8448, that is, a maximum length supported by an encoding matrix used in the LDPC encoding scheme. Certainly, if the encoding matrix used in the LDPC encoding scheme can support a greater length in the future, the third length may alternatively be another value.

In the communication protocol, the first rule in the implementation 5 may be represented as follows:

if Code Type indicator == 0
Use Polar code and no CB segmentation;
else
Use LDPC and CB segmentation according to K_{cb} = 3840;
end if
K_{cb} is a third length, and the third length is 3840.

Optionally, the first indication information further indicates a segmentation scheme used for the 2^{nd}-stage information. For example, when a value of the first indication information is 1, it indicates that the first communication apparatus encodes the 2^{nd}-stage information based on the polar code encoding scheme without segmentation. When a value of the first indication information is 0, it indicates that the first communication apparatus segments the 2^{nd}-stage information based on the third length, and encodes segmented 2^{nd}-stage information based on the LDPC encoding scheme. For another example, when a value of the first indication information is 0, the first communication apparatus encodes the 2^{nd}-stage information based on the LDPC encoding scheme, and the first communication apparatus segments the 2^{nd}-stage information based on the third length. When a value of the first indication information is 1, it indicates that the first communication apparatus encodes the 2^{nd}-stage information based on the polar code encoding scheme without segmentation.

6. The first rule includes: in correspondence to a modulation order of the 2^{nd}-stage information less than or equal to a first threshold, encoding the 2^{nd}-stage information based on a polar code encoding scheme without segmentation; or in correspondence to a modulation order of the 2^{nd}-stage information greater than the first threshold, segmenting the 2^{nd}-stage information based on a third length, and then encoding segmented 2^{nd}-stage information based on an LDPC encoding scheme.

Optionally, the 1^{st}-stage information indicates the modulation order of the 2^{nd}-stage information. For example, the 1^{st}-stage information includes a field indicating the modulation order of the 2^{nd}-stage information.

Optionally, the first threshold is 2. Certainly, the first threshold may alternatively be another value, and may be determined with reference to encoding performance of various encoding schemes.

Optionally, the third length is 3840 or 8448, that is, a maximum length supported by an encoding matrix used in the LDPC encoding scheme. Certainly, if the encoding matrix used in the LDPC encoding scheme can support a greater length in the future, the third length may alternatively be another value.

If the modulation order of the 2^{nd}-stage information is less than or equal to 2, the first communication apparatus may encode the 2^{nd}-stage information based on the polar code encoding scheme without segmentation. Usually, if the modulation order is small, a length of the 2^{nd}-stage information is short. Therefore, when the modulation order of the 2^{nd}-stage information is less than or equal to 2, better encoding performance is obtained by the first communication apparatus through encoding based on the polar code encoding scheme. If the modulation order of the 2^{nd}-stage information is greater than 2, the first communication apparatus segments the 2^{nd}-stage information based on the third length, and then encodes the segmented 2^{nd}-stage information based on the LDPC encoding scheme. When the modulation order of the 2^{nd}-stage information is greater than 2, better encoding performance is obtained by the first communication apparatus through encoding based on the LDPC encoding scheme. The first communication apparatus segments the 2^{nd}-stage information based on the third length, so that a length of each segment of the segmented 2^{nd}-stage information is the third length. Certainly, a length of a last segment of the segmented 2^{nd}-stage information may be less than or equal to the third length.

7. The first rule includes: in correspondence to the 2^{nd}-stage information that is first-type information, encoding the 2^{nd}-stage information based on a polar code encoding scheme without segmentation; or in correspondence to the 2^{nd}-stage information that is second-type information or third-type information, segmenting the 2^{nd}-stage information based on a fourth length, and encoding segmented 2^{nd}-stage information based on an LDPC encoding scheme.

The first communication apparatus segments the 2^{nd}-stage information, so that a length of each segment of the segmented 2^{nd}-stage information is the fourth length. Certainly, a length of a last segment of the segmented 2^{nd}-stage information may be less than or equal to the fourth length. Then, the first communication apparatus encodes the segmented 2^{nd}-stage information based on the LDPC encoding scheme.

Optionally, the first-type information is T-MIMO CSI, the second-type information is sensing-related information, and the third-type information is AI training information. A data length of the T-MIMO CSI is usually short. Therefore, the first communication apparatus encodes the 2^{nd}-stage information based on the polar code encoding scheme, to improve encoding performance. However, data lengths corresponding to the sensing-related information and the AI training data are long. Therefore, the first communication apparatus encodes the segmented 2^{nd}-stage information based on the LDPC encoding scheme, thereby helping improve encoding performance.

Optionally, the fourth length is determined based on a payload size and a channel coding rate of the 2^{nd}-stage information. For example, in correspondence to the payload size of the 2^{nd}-stage information less than or equal to 292, or in correspondence to the payload size of the 2^{nd}-stage information less than or equal to 3824 and the channel coding rate of the 2^{nd}-stage information less than or equal to 0.25, the fourth length is 3840; or in correspondence to the payload size of the 2^{nd}-stage information greater than 292, or in correspondence to the payload size of the 2^{nd}-stage information greater than 3824 and the channel coding rate of the 2^{nd}-stage information greater than 0.25, the fourth length is 8448, that is, a maximum length supported by an encoding matrix used in the LDPC encoding scheme. Certainly, if the encoding matrix used in the LDPC encoding scheme can support a greater length in the future, the fourth length may alternatively be another value.

For example, if the payload size of the 2^{nd}-stage information is less than or equal to 292, or if the payload size of the 2^{nd}-stage information is less than or equal to 3824 and the channel coding rate of the 2^{nd}-stage information is less than or equal to 0.25, the first communication apparatus segments the 2^{nd}-stage information based on the fourth length of 3840, and then performs LDPC encoding on the segmented 2^{nd}-stage information based on a BG 2. Otherwise, the first communication apparatus segments the 2^{nd}-stage information based on the fourth length of 8448, and then performs LDPC encoding on the segmented 2^{nd}-stage information based on a BG 1.

In a possible implementation, different formats of the 2^{nd}-stage information may be defined in the communication protocol based on a type of information carried in the 2^{nd}-stage information. For example, a format of the 2^{nd}-stage information carrying the first-type information is a 2^{nd}-stage information format A, a format of the 2^{nd}-stage information carrying the second-type information is a 2^{nd}-stage information format B, and a format of the 2^{nd}-stage information carrying the third-type information is a 2^{nd}-stage information format C. For example, the 2^{nd}-stage information is 2^{nd}-stage UCI, a format of the 2^{nd}-stage information carrying the first-type information is 2^{nd}-stage UCI Format-A, a format of the 2^{nd}-stage information carrying the second-type information is 2^{nd}-stage UCI Format-B, and a format of the 2^{nd}-stage information carrying the third-type information is 2^{nd}-stage UCI Format-C. For another example, the 2^{nd}-stage information is 2^{nd}-stage DCI, a format of the 2^{nd}-stage information carrying the first-type information is 2^{nd}-stage DCI Format-A, a format of the 2^{nd}-stage information carrying the second-type information is 2^{nd}-stage DCI Format-B, and a format of the 2^{nd}-stage information carrying the third-type information is 2^{nd}-stage DCI Format-C.

8. The first rule includes: determining a fifth length based on a payload size and a channel coding rate of the 2^{nd}-stage information; and segmenting the 2^{nd}-stage information based on the fifth length, and then encoding segmented 2^{nd}-stage information based on an LDPC encoding scheme.

In this implementation, the 1^{st}-stage information is transmitted on a control channel, and the 2^{nd}-stage information is transmitted on a shared channel. The first communication apparatus segments the 2^{nd}-stage information, so that a payload length of each segment of the segmented 2^{nd}-stage information is the fifth length. Certainly, a length of a last segment of the segmented 2^{nd}-stage information may be less than or equal to the fifth length. Then, the first communication apparatus encodes the segmented 2^{nd}-stage information based on the LDPC encoding scheme.

Optionally, in correspondence to the payload size of the 2^{nd}-stage information less than or equal to 292, or in correspondence to the payload size of the 2^{nd}-stage information less than or equal to 3824 and the channel coding rate of the 2^{nd}-stage information less than or equal to 0.25, the fifth length is 3840; or in correspondence to the payload size of the 2^{nd}-stage information greater than 292, or in correspondence to the payload size of the 2^{nd}-stage information greater than 3824 and the channel coding rate of the 2^{nd}-stage information greater than 0.25, the fifth length is 8448, that is, a maximum length supported by an encoding matrix used in the LDPC encoding scheme. Certainly, if the encoding matrix used in the LDPC encoding scheme can support a greater length in the future, the fifth length may alternatively be another value.

Optionally, the 2^{nd}-stage information includes L1 information.

Optionally, the 2^{nd}-stage information includes at least one of the following: T-MIMO CSI, sensing-related information, or AI training information.

402: The first communication apparatus outputs the 1^{st}-stage information and the 2^{nd}-stage information.

For the 1^{st}-stage information and the 2^{nd}-stage information, refer to related descriptions in the foregoing step 401.

The first communication apparatus may output the 1^{st}-stage information and the 2^{nd}-stage information to the second communication apparatus.

It should be noted that the first communication apparatus may send the 1^{st}-stage information and the 2^{nd}-stage information at the same time, or may send the 1^{st}-stage information first and then send the 2^{nd}-stage information. This is not limited in this disclosure.

403: The second communication apparatus determines a decoding scheme and/or a segmentation scheme of the 2^{nd}-stage information according to a second rule.

The following describes some possible implementations of the second rule. This disclosure is also applicable to another implementation. This is not limited in this disclosure.

1. Based on the implementation 1 of the first rule in the step 401, optionally, the second rule includes: segmenting the 2^{nd}-stage information based on a first length, and decoding segmented 2^{nd}-stage information based on the polar code decoding scheme, where the first length is 2ⁿ, and n is a positive integer.

For the first length, refer to the related descriptions in the step 401.

2. Based on the implementation 2 of the first rule in the step 401, optionally, the second rule includes: segmenting the 2^{nd}-stage information based on a second length, and decoding segmented 2^{nd}-stage information based on the LDPC decoding scheme.

For the second length, refer to the related descriptions in the step 401.

3. Based on the implementation 3 of the first rule in the step 401, optionally, the second rule includes: determining a decoding scheme and/or a segmentation scheme of the 2^{nd}-stage information based on a payload size and a channel coding rate of the 2^{nd}-stage information.

Optionally, in correspondence to the payload size of the 2^{nd}-stage information less than or equal to 384 and the channel coding rate of the 2^{nd}-stage information less than or equal to 0.5, or in correspondence to the payload size of the 2^{nd}-stage information less than or equal to 140, the 2^{nd}-stage information is encoded based on a polar code decoding scheme without segmentation; or in correspondence to the payload size of the 2^{nd}-stage information greater than 384 and the channel coding rate of the 2^{nd}-stage information greater than 0.5, or in correspondence to the payload size of the 2^{nd}-stage information greater than 140, the 2^{nd}-stage information is segmented based on a segment length of 3840, and segmented 2^{nd}-stage information is decoded based on an LDPC decoding scheme. It should be noted that the second communication apparatus segments the 2^{nd}-stage information based on the segment length of 3840, that is, a length of each segment of the segmented 2^{nd}-stage information is 3840. Certainly, a length of a last segment of the segmented 2^{nd}-stage information may be less than or equal to 3840.

4. Based on the implementation 4 of the first rule in the step 401, optionally, the second rule includes: determining a decoding scheme and/or a segmentation scheme of the 2^{nd}-stage information based on a length of the 2^{nd}-stage information received by the second communication apparatus, a number of available physical resources, and/or a modulation order.

Optionally, in correspondence to the length of the 2^{nd}-stage information received by the second communication apparatus less than or equal to a maximum length, a number of segments of the 2^{nd}-stage information is determined based on a maximum decoding length supported by a polar code decoding scheme and the number of available physical resources, the 2^{nd}-stage information is segmented based on the number of segments of the 2^{nd}-stage information, and segmented 2^{nd}-stage information is decoded based on the polar code decoding scheme; or in correspondence to the length of the 2^{nd}-stage information received by the second communication apparatus greater than the maximum length, a number of segments of the 2^{nd}-stage information is determined based on a maximum decoding length supported by an LDPC decoding scheme and the number of available physical resources, the 2^{nd}-stage information is segmented based on the number of segments of the 2^{nd}-stage information, and segmented 2^{nd}-stage information is decoded based on the LDPC decoding scheme. For the maximum length, refer to the related descriptions in the step 401.

Optionally, the maximum decoding length supported by the polar code decoding scheme is 1024.

Optionally, the maximum decoding length supported by the LDPC decoding scheme is 3840.

Optionally, the total number of available physical resources is Eₜₒₜₐₗ. The maximum decoding length supported by the polar decoding scheme or the maximum decoding length supported by the LDPC decoding scheme is represented as Nₘ. If Eᵣₑₛₜ is less than the first threshold, the number C of segments=C₁. Otherwise, the number C of segments=C₁+1. Eᵣₑₛₜ=Eₜₒₜₐₗ−C₁×Nₘ, C₁=[Eₜₒₜₐₗ/Nₘ]. Optionally, the first threshold is greater than or equal to

$$\frac{1 {N}_{m}}{2} .$$

For example, the first threshold is equal to

$$\frac{9 {N}_{m}}{16} .$$

Eᵣₑₛₜ indicates a number of remaining available physical resources. In other words, if Eᵣₑₛₜ is greater than or equal to half of Nₘ, the number of segments may be increased by one.

5. Based on the implementation 5 of the first rule in the step 401, the 1^{st}-stage information includes first indication information, and the first indication information indicates an encoding scheme used for the 2^{nd}-stage information. Optionally, the second rule includes: in correspondence to the first indication information indicating that the polar code encoding scheme is used to encode the 2^{nd}-stage information, decoding the 2^{nd}-stage information based on a polar decoding scheme without segmentation; or in correspondence to the first indication information indicating that the LDPC encoding scheme is used to encode the 2^{nd}-stage information, segmenting the 2^{nd}-stage information based on a third length, and decoding segmented 2^{nd}-stage information based on an LDPC decoding scheme.

For the first indication information and the third length, refer to the foregoing related descriptions.

6. Based on the implementation 6 of the first rule in the step 401, optionally, the second rule includes: in correspondence to a modulation order of the 2^{nd}-stage information less than or equal to the first threshold, decoding the 2^{nd}-stage information based on a polar code decoding scheme without segmentation; or in correspondence to a modulation order of the 2^{nd}-stage information greater than the first threshold, segmenting the 2^{nd}-stage information based on a third length, and decoding segmented 2^{nd}-stage information based on an LDPC decoding scheme.

For the third length, refer to the foregoing related descriptions.

7. Based on the implementation 6 of the first rule in the step 401, optionally, the second rule includes: in correspondence to the 2^{nd}-stage information that is first-type information, decoding the 2^{nd}-stage information based on a polar code decoding scheme without segmentation; or in correspondence to the 2^{nd}-stage information that is second-type information or third-type information, segmenting the 2^{nd}-stage information based on a fourth length, and decoding segmented 2^{nd}-stage information based on an LDPC decoding scheme.

For the first-type information, the second-type information, and the third-type information, refer to the related descriptions in the step 401. Details are not described herein again. For the fourth length, refer to the related descriptions in the step 401. Details are not described herein again.

8. Based on the implementation 7 of the first rule in the step 401, optionally, the second rule includes: determining a fifth length based on a payload size and a channel coding rate of the 2^{nd}-stage information; and segmenting the 2^{nd}-stage information based on the fifth length, and decoding segmented 2^{nd}-stage information based on an LDPC decoding scheme.

In this implementation, the 1^{st}-stage information is transmitted on a control channel, and the 2^{nd}-stage information is transmitted on a shared channel. The second communication apparatus segments the 2^{nd}-stage information, so that a payload size of each segment of the segmented 2^{nd}-stage information is the fifth length. Certainly, a length of a last segment of the segmented 2^{nd}-stage information may be less than or equal to the fifth length. Then, the second communication apparatus decodes the segmented 2^{nd}-stage information based on the LDPC decoding scheme.

Optionally, in correspondence to the payload size of the 2^{nd}-stage information less than or equal to 292, or in correspondence to the payload size of the 2^{nd}-stage information less than or equal to 3824 and the channel coding rate of the 2^{nd}-stage information less than or equal to 0.25, the fifth length is 3840; or in correspondence to the payload size of the 2^{nd}-stage information greater than 292, or in correspondence to the payload size of the 2^{nd}-stage information greater than 3824 and the channel coding rate of the 2^{nd}-stage information greater than 0.25, the fifth length is 8448.

404: The second communication apparatus decodes the 2^{nd}-stage information based on the decoding scheme and/or the segmentation scheme and the 1^{st}-stage information.

The second communication apparatus determines, based on the 1^{st}-stage information, a resource location of the 2^{nd}-stage information. Then, the second communication apparatus receives the 2^{nd}-stage information based on the resource location. The second communication apparatus segments the 2^{nd}-stage information based on the segmentation scheme, and then decodes the segmented 2^{nd}-stage information based on the decoding scheme.

In this embodiment of this disclosure, the first communication apparatus determines the 1^{st}-stage information and the 2^{nd}-stage information that correspond to the same service type. The 1^{st}-stage information is transmitted on the control channel and/or the shared channel. The 2^{nd}-stage information is transmitted on the shared channel. The 2^{nd}-stage information is generated based on the encoding scheme and/or the segmentation scheme that are/is determined according to the first rule. The 1^{st}-stage information is for decoding the 2^{nd}-stage information. The first communication apparatus outputs the 1^{st}-stage information and the 2^{nd}-stage information. It can be learned that the 2^{nd}-stage information is generated based on the encoding scheme and/or the segmentation scheme that are/is determined according to the first rule, thereby transmitting the 2^{nd}-stage information. This helps improve encoding performance of the 2^{nd}-stage information, and compensates for not supporting segmenting the 2^{nd}-stage information in a current communication protocol. The transmission manner of the 2^{nd}-stage information can adapt to different service scenarios of non-conventional communication information, thereby flexibly sending the 2^{nd}-stage information.

This disclosure further provides another embodiment. The following describes a technical solution of this embodiment with reference to step a to step c.

Step a: A second communication apparatus sends 1^{st}-stage information 1 to a first communication apparatus. The 1^{st}-stage information 1 includes first indication information, and the first indication information indicates an encoding scheme used for 2^{nd}-stage information. Correspondingly, the first communication apparatus receives the 1^{st}-stage information 1 from the second communication apparatus.

Optionally, the 1^{st}-stage information 1 is transmitted on a control channel. For example, the 1^{st}-stage information 1 is 1^{st}-stage DCI, and the 1^{st}-stage DCI is transmitted on a PUCCH.

Optionally, the first indication information is a first field in the 1^{st}-stage information 1. For example, the first field is 1 bit, 2 bits, or 3 bits. A length of the first field is not limited in this disclosure.

Optionally, when a value of the first field is 0, it indicates that the 2^{nd}-stage information is encoded based on a polar code encoding scheme; or when a value of the first field is 1, it indicates that the 2^{nd}-stage information is encoded based on an LDPC encoding scheme. Alternatively, when a value of the first field is 0, it indicates that the 2^{nd}-stage information is encoded based on an LDPC encoding scheme; or when a value of the first field is 1, it indicates that the 2^{nd}-stage information is encoded based on a polar code encoding scheme.

For example, the 1^{st}-stage information 1 is 1^{st}-stage DCI, and the 2^{nd}-stage information is 2^{nd}-stage UCI. A resource configuration field (for example, time-frequency resource assignment, a resource reservation period, a DMRS pattern, a 2^{nd}-stage UCI format, an MCS, a Beta_offset indicator, a number of DMRS ports, and a code type indicator) indicating the 2^{nd}-stage UCI are newly added to the 1^{st}-stage DCI. In other words, the first field is the code type indicator, and the code type indicator indicates the encoding scheme used for the 2^{nd}-stage UCI. For example, as shown in Table 1, the code type indicator is newly added to the 1^{st}-stage DCI.

TABLE 1

| Field | Bits | Reference |
|---|---|---|
| Identifier for DCI formats | 1 | |
| Frequency domain resource assignment | 4 | Uplink bandwidth part (UL BWP) |
| | | N_RB is variable; |
| | | it indicates a PRB location in the BWP; |
| | | and |
| | | a number of bits and values of the bits |
| | | are determined as described herein. |
| Time domain resource assignment | X | Carries a row index of an item in a |
| | | PUSCH location list in radio resource |
| | | control (RRC). |
| Frequency hopping flag | 1 | |
| Modulation and coding scheme | 5 | Refer to the table in clause 6.1.4 of the |
| | | standard 38.214. |
| New data indicator | 1 | |
| Redundancy version | 2 | 0, 1, 2, and 3 |
| HARQ process number | 4 | |
| Transmit power control (TPC) command | 2 | Refer to Table 7.1.1-1 of the standard |
| for scheduled PUSCH | | 38.213. |
| Uplink indicator (UL | 0 or 1 | 0 bit: SUL not configured |
| indicator)/Supplementary uplink | | 1 bit: SUL configured |
| indicator (SUL indicator) | | |
| Code type indicator | 1 | 0: Polar |
| | | 1: LDPC |

In this implementation, if the first indication information indicates that the polar code encoding scheme is used to encode the 2^{nd}-stage information, the first communication apparatus encodes the 2^{nd}-stage information without segmentation by default. If the first indication information indicates that the LDPC encoding scheme is used to encode the 2^{nd}-stage information, the first communication apparatus segments the 2^{nd}-stage information based on a third length. Optionally, the third length is 3840 or 8448, that is, a maximum length supported by an encoding matrix used in the LDPC encoding scheme. Certainly, if the encoding matrix used in the LDPC encoding scheme can support a greater length in the future, the third length may alternatively be another value.

In a communication protocol, the following may be used for representation:

if Code Type indicator == 0
Use Polar code and no CB segmentation;
else
Use LDPC and CB segmentation according to K_{cb} = 3840;
end if
K_{cb} is the third length.

Optionally, the first indication information further indicates a segmentation scheme used for the 2^{nd}-stage information. For example, when a value of the first indication information is 1, it indicates that the first communication apparatus encodes the 2^{nd}-stage information based on the polar code encoding scheme without segmentation. When a value of the first indication information is 0, it indicates that the first communication apparatus segments the 2^{nd}-stage information based on the third length, and encodes segmented 2^{nd}-stage information based on the LDPC encoding scheme. For another example, when a value of the first indication information is 0, the first communication apparatus encodes the 2^{nd}-stage information based on the LDPC encoding scheme, and the first communication apparatus segments the 2^{nd}-stage information based on the third length. When a value of the first indication information is 1, it indicates that the first communication apparatus encodes the 2^{nd}-stage information based on the polar code encoding scheme without segmentation.

Step b: The first communication apparatus sends the 2^{nd}-stage information to the second communication apparatus. Correspondingly, the second communication apparatus receives the 2^{nd}-stage information from the first communication apparatus.

The 2^{nd}-stage information is generated based on the encoding scheme and/or the segmentation scheme that are/is indicated by the first indication information.

Optionally, the 2^{nd}-stage information is transmitted on a shared channel. For example, the 2^{nd}-stage information is 2^{nd}-stage UCI, and the 2^{nd}-stage UCI is transmitted on a PUSCH.

Step c: The second communication apparatus determines a decoding scheme and/or a segmentation scheme of the 2^{nd}-stage information based on the encoding scheme and/or the segmentation scheme indicated by the first indication information.

In a possible implementation, the first indication information indicates the encoding scheme used for the 2^{nd}-stage information. If the first indication information indicates that the polar code encoding scheme is used for the 2^{nd}-stage information, the second communication apparatus decodes the 2^{nd}-stage information based on a polar decoding scheme without segmentation. If the first indication information indicates that the LDPC encoding scheme is used for the 2^{nd}-stage information, the second communication apparatus segments the 2^{nd}-stage information based on a third length, and the second communication apparatus decodes segmented 2^{nd}-stage information based on an LDPC decoding scheme. For the third length, refer to the related descriptions in the embodiment shown in FIG. 4.

In another possible implementation, the first indication information indicates the encoding scheme and the segmentation scheme of the 2^{nd}-stage information. If the first indication information indicates that the 2^{nd}-stage information is encoded based on the polar code encoding scheme without segmentation, the second communication apparatus decodes the 2^{nd}-stage information based on the polar decoding scheme without segmentation. If the first indication information indicates that the 2^{nd}-stage information is segmented based on the third length, and the 2^{nd}-stage information is encoded based on the LDPC encoding scheme, the second communication apparatus segments the 2^{nd}-stage information based on the third length, and the second communication apparatus decodes segmented 2^{nd}-stage information based on the LDPC decoding scheme. For the third length, refer to the related descriptions in the embodiment shown in FIG. 4.

Optionally, this embodiment further includes step c1. The step c1 may be performed before the step c.

Step c1: The first communication apparatus sends 1^{st}-stage information 2 to the second communication apparatus. Correspondingly, the second communication apparatus receives the 1^{st}-stage information 2 from the first communication apparatus.

The 1^{st}-stage information 2 is for decoding the 2^{nd}-stage information. Optionally, the 1^{st}-stage information 2 includes information about a resource occupied for decoding the 2^{nd}-stage information. In other words, the second communication apparatus may parse the 1^{st}-stage information 2, to determine a time-frequency resource location occupied by the 2^{nd}-stage information and the like. The second communication apparatus may receive the 2^{nd}-stage information at the time-frequency resource location. For some possible fields of the information about the resource occupied for decoding the 2^{nd}-stage information, refer to the related descriptions in the embodiment shown in FIG. 4. Details are not described herein again.

Optionally, the 1^{st}-stage information 2 does not include at least one of the following: a shared channel indicator, a new data indicator, a redundancy version, a priority indicator, a HARQ process number, a downlink assignment index, PDSCH-to-HARQ feedback timing, a code block group transmission indicator, code block group flush information, a PDSCH group index, a number of requested PDSCH groups, a one-shot HARQ, a new feedback indicator, an antenna port, a transmission configuration indicator TCI, a sounding reference signal request, DMRS sequence initialization, or power control. For functions of these fields that are not included in the 1^{st}-stage information 2, refer to the related descriptions in the embodiment shown in FIG. 4. In this way, the 1^{st}-stage information 2 is simplified, and the 1^{st}-stage information 2 is encoded without segmentation. A payload size of the 1^{st}-stage information 2 is further reduced, and blind detection complexity of the second communication apparatus is reduced.

Optionally, a length of the 1^{st}-stage information is less than or equal to a sixth length. For example, the sixth length is 70.

Optionally, the 2^{nd}-stage information includes T-MIMO CSI, sensing-related information, artificial intelligence-related information, the shared channel indicator, the new data indicator, the redundancy version, the priority indicator, the HARQ process number, the downlink assignment index, the PDSCH-to-HARQ feedback timing, the code block group transmission indicator, the code block group flush information, the PDSCH group index, the number of requested PDSCH groups, the one-shot HARQ, the new feedback indicator, the antenna port, the transmission configuration indicator TCI, the sounding reference signal request, the DMRS sequence initialization, or the power control. It can be learned that a field in original 1^{st}-stage information 2 is moved to the 2^{nd}-stage information, to simplify the 1^{st}-stage information 2.

The 1^{st}-stage information 2 and the 2^{nd}-stage information correspond to a same service type, that is, the 1^{st}-stage information 2 and the 2^{nd}-stage information are for a same service. In other words, the first communication apparatus sends the 1^{st}-stage information 2 and the 2^{nd}-stage information for the same service. In this way, the second communication apparatus parses the 1^{st}-stage information 2, to determine a time-frequency resource on which the 2^{nd}-stage information is located. Then, the second communication apparatus may parse the 2^{nd}-stage information, to obtain related data of the service. For example, the 1^{st}-stage information 2 is 1^{st}-stage UCI, and the 2^{nd}-stage information is 2^{nd}-stage UCI.

After the second communication apparatus receives the 1^{st}-stage information 2, the second communication apparatus parses the 1^{st}-stage information 2, to obtain a resource location of the 2^{nd}-stage information. The second communication apparatus receives the 2^{nd}-stage information based on the resource location.

Optionally, the 1^{st}-stage information 2 is carried in at least one of the following: an SR, a HARQ-ACK, or CSI. The 2^{nd}-stage information is carried in an intra RAN, sensing-related information, AI training information, and/or control information with a large payload size in the T-MIMO CSI.

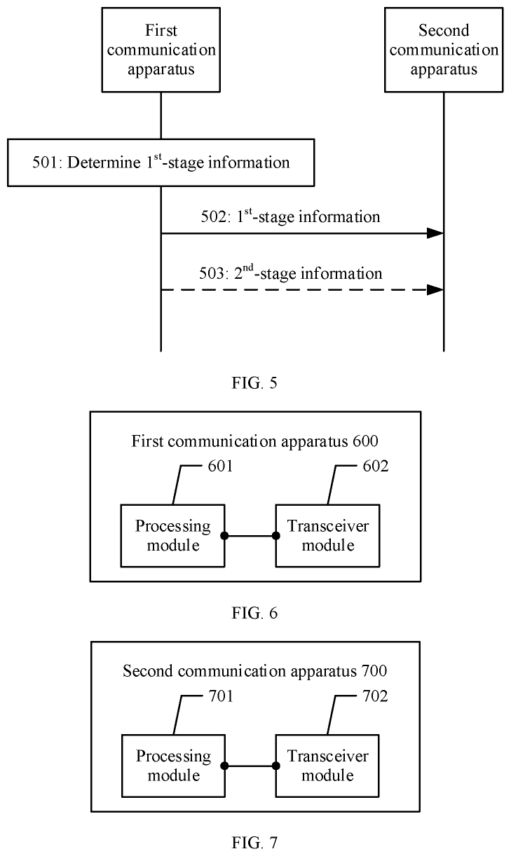

FIG. 5 is a diagram of an embodiment of a 1^{st}-stage information sending method according to an embodiment of this disclosure. Refer to FIG. 5. The method includes the following steps.

501: A first communication apparatus determines 1^{st}-stage information.

The 1^{st}-stage information includes information about a resource occupied for decoding 2^{nd}-stage information. In other words, the 1^{st}-stage information is for decoding the 2^{nd}-stage information. In other words, the second communication apparatus may parse the 1^{st}-stage information, to determine a resource location occupied by the 2^{nd}-stage information and the like. The second communication apparatus may receive the 2^{nd}-stage information at the resource location indicated by the 1^{st}-stage information. For the information about the resource occupied for decoding the 2^{nd}-stage information, refer to the related descriptions in the embodiment shown in FIG. 4. A length of the 1^{st}-stage information is less than or equal to a first length. Optionally, the first length is 70.

Optionally, the 1^{st}-stage information does not include a shared channel indicator, a new data indicator, a redundancy version, a priority indicator, a HARQ process number, a downlink assignment index, PDSCH-to-HARQ feedback timing, a code block group transmission indicator, code block group flush information, a PDSCH group index, a number of requested PDSCH groups, a one-shot HARQ, a new feedback indicator, an antenna port, a transmission configuration indicator TCI, a sounding reference signal request, DMRS sequence initialization, or power control. For functions of these fields that are not included in the 1^{st}-stage information, refer to the related descriptions in the embodiment shown in FIG. 4. In this way, the 1^{st}-stage information is simplified, and the 1^{st}-stage information is encoded without segmentation. A payload size of the 1^{st}-stage information is further reduced, and blind detection complexity of the second communication apparatus is reduced.

Optionally, the 1^{st}-stage information includes 1^{st}-stage control information. For example, the first communication apparatus is a terminal device, and the second communication apparatus is a network device. The 1^{st}-stage control information is 1^{st}-stage UCI. For another example, the first communication apparatus is a network device, and the second communication apparatus is a terminal device. The 1^{st}-stage control information is 1^{st}-stage DCI. For another example, the first communication apparatus is a first terminal device, and the second communication apparatus is a second terminal device. The 1^{st}-stage control information is 1^{st}-stage SCI.

Optionally, the 1^{st}-stage information is carried in at least one of the following: an SR, a HARQ-ACK, or CSI. In other words, the 1^{st}-stage information includes control information with a small payload size.

502: The first communication apparatus outputs the 1^{st}-stage information.

Optionally, the first communication apparatus sends the 1^{st}-stage information to the second communication apparatus. Correspondingly, the second communication apparatus receives the 1^{st}-stage information from the first communication apparatus.

Optionally, the 1^{st}-stage information is transmitted on a control channel and/or a shared channel.

In a possible implementation, the first communication apparatus is a network device, and the second communication apparatus is a terminal device. The 1^{st}-stage information is transmitted on a PDCCH and/or a PDSCH.

In another possible implementation, the first communication apparatus is a terminal device, and the second communication apparatus is a network device. The 1^{st}-stage information is transmitted on a PUCCH and/or a PUSCH.

In still another possible implementation, the first communication apparatus is a first terminal device, and the second communication apparatus is a second terminal device. The 1^{st}-stage information is transmitted on a PSCCH and/or a PSSCH.

Optionally, the embodiment shown in FIG. 5 further includes step 503. The step 503 may be performed after the step 502.

503: The first communication apparatus outputs the 2^{nd}-stage information.

Optionally, the first communication apparatus sends the 2^{nd}-stage information to the second communication apparatus. Correspondingly, the second communication apparatus receives the 2^{nd}-stage information from the first communication apparatus.

The 1^{st}-stage information includes the information about the resource occupied for decoding the 2^{nd}-stage information. The second communication apparatus determines, based on the information about the resource occupied for decoding the 2^{nd}-stage information, the resource location of the 2^{nd}-stage information. Then, the second communication apparatus receives the 2^{nd}-stage information based on the resource location. The second communication apparatus decodes the 2^{nd}-stage information.

Optionally, the 2^{nd}-stage information includes L1 information.

Optionally, the 2^{nd}-stage information includes at least one of the following: T-MIMO CSI, sensing-related information, or AI training information.

Optionally, the 2^{nd}-stage information is transmitted on a shared channel.

In a possible implementation, the first communication apparatus is a network device, and the second communication apparatus is a terminal device. The 2^{nd}-stage information is transmitted on the PDSCH.

In another possible implementation, the first communication apparatus is a terminal device, and the second communication apparatus is a network device. The 2^{nd}-stage information is transmitted on the PUSCH.

In still another possible implementation, the first communication apparatus is a first terminal device, and the second communication apparatus is a second terminal device. The 2^{nd}-stage information is transmitted on the PSSCH.

It should be noted that the 2^{nd}-stage information is transmitted on the shared channel in the foregoing several scenarios. Optionally, the 2^{nd}-stage information may alternatively be transmitted on a newly defined shared channel. For example, a corresponding shared channel is defined based on a type of service information carried in the 2^{nd}-stage information, and the 2^{nd}-stage information is transmitted on the newly defined shared channel. For example, the 2^{nd}-stage information carries sensing-related information, the newly defined shared channel may be referred to as a PSDSCH or a PSUSCH, and the 2^{nd}-stage information may be carried on the PSDSCH or the PSUSCH. For another example, the 2^{nd}-stage information carries AI training data, and the newly defined shared channel may be referred to as a PADSCH or a PAUSCH.

Optionally, the 2^{nd}-stage information includes 2^{nd}-stage control information. For example, the first communication apparatus is a terminal device, and the second communication apparatus is a network device. The 2^{nd}-stage control information is 2^{nd}-stage UCI. For another example, the first communication apparatus is a network device, and the second communication apparatus is a terminal device. The 2^{nd}-stage control information is 2^{nd}-stage DCI. For another example, the first communication apparatus is a first terminal device, and the second communication apparatus is a second terminal device. The 2^{nd}-stage control information is 2^{nd}-stage SCI.

Optionally, the name of the 2^{nd}-stage information may also be a newly defined name. For example, the 2^{nd}-stage information carries sensing-related information, and the 2^{nd}-stage information may be referred to as 2^{nd}-stage USI or 2^{nd}-stage DSI. For another example, the 2^{nd}-stage information is carried in AI training data, and the 2^{nd}-stage information may be referred to as 2^{nd}-stage UAI or 2^{nd}-stage DAI.

Optionally, the 2^{nd}-stage information includes at least one of the following: T-MIMO CSI, sensing-related information, artificial intelligence-related information, the shared channel indicator, the new data indicator, the redundancy version, the priority indicator, the HARQ process number, the downlink assignment index, the PDSCH-to-HARQ feedback timing, the code block group transmission indicator, the code block group flush information, the PDSCH group index, the number of requested PDSCH groups, the one-shot HARQ, the new feedback indicator, the antenna port, the transmission configuration indicator TCI, the sounding reference signal request, the DMRS sequence initialization, or the power control. For functions of these fields that are included in the 2^{nd}-stage information, refer to the related descriptions in the embodiment shown in FIG. 4. It can be learned that a field in original 1^{st}-stage information is moved to the 2^{nd}-stage information, to simplify the 1^{st}-stage information.

The 1^{st}-stage information and the 2^{nd}-stage information correspond to a same service type, that is, the 1^{st}-stage information and the 2^{nd}-stage information are for a same service. In other words, the first communication apparatus sends the 1^{st}-stage information and the 2^{nd}-stage information for the same service. In this way, the second communication apparatus parses the 1^{st}-stage information, to determine a time-frequency resource on which the 2^{nd}-stage information is located. Then, the second communication apparatus may parse the 2^{nd}-stage information, to obtain related data of the service. For example, for some specific communication scenarios, the name of the 1^{st}-stage information and the name of the 2^{nd}-stage information may indicate that the 1^{st}-stage information and the 2^{nd}-stage information are for the same service. For example, in an SL scenario, the 1^{st}-stage information is 1^{st}-stage SCI, and the 2^{nd}-stage information is 2^{nd}-stage SCI. For another example, the 1^{st}-stage information includes a second field, and the second field indicates the service. For example, the 2^{nd}-stage information carries sensing-related information, the 1^{st}-stage information includes a second field, and the second field indicates a sensing service. It can be learned that both the 1^{st}-stage information and the 2^{nd}-stage information are sent for the sensing service.

In this embodiment of this disclosure, the first communication apparatus determines the 1^{st}-stage information, where the 1^{st}-stage information includes the information about the resource occupied for decoding the 2^{nd}-stage information, and the length of the 1^{st}-stage information is less than or equal to the first length; and the first communication apparatus sends the 1^{st}-stage information. In this way, the 1^{st}-stage information is simplified, and the 1^{st}-stage information is encoded without segmentation. A payload size of the 1^{st}-stage information is further reduced, and blind detection complexity of the second communication apparatus is reduced.

The following describes the first communication apparatus and the second communication apparatus provided in embodiments of this disclosure.

FIG. 6 is a diagram of a structure of a first communication apparatus according to an embodiment of this disclosure. Refer to FIG. 6. The first communication apparatus 600 may be configured to perform the processes performed by the first communication apparatus in the embodiments shown in FIG. 4 and FIG. 5. For details, refer to the related descriptions in the foregoing method embodiments.

The first communication apparatus 600 includes a processing module 601 and a transceiver module 602.

The processing module 601 is configured to process data. The transceiver module 602 may implement a corresponding communication function. The transceiver module 602 may also be referred to as a communication interface or a communication module.

Optionally, the first communication apparatus 600 may further include a storage module. The storage module may be configured to store instructions and/or data. The processing module 601 may read the instructions and/or the data in the storage module, to enable the first communication apparatus to implement the foregoing method embodiments.

The first communication apparatus 600 may be configured to perform actions performed by the first communication apparatus in the foregoing method embodiments. The first communication apparatus 600 may be a first communication apparatus or a component that may be disposed in a first communication apparatus. The processing module 601 is configured to perform a processing-related operation on a first communication apparatus side in the foregoing method embodiments. The transceiver module 602 is configured to perform a receiving-related operation on the first communication apparatus side in the foregoing method embodiments. For example, the first communication apparatus 600 is configured to perform the following solution.

The processing module 601 is configured to determine 1^{st}-stage information and 2^{nd}-stage information that correspond to a same service type, where the 1^{st}-stage information is transmitted on a control channel and/or a shared channel, the 2^{nd}-stage information is transmitted on the shared channel, the 2^{nd}-stage information is generated based on an encoding scheme and/or a segmentation scheme determined according to a first rule, and the 1^{st}-stage information is for decoding the 2^{nd}-stage information.

The transceiver module 602 is configured to output the 1^{st}-stage information and the 2^{nd}-stage information.

For another example, the first communication apparatus 600 is configured to perform the following solution.

The processing module 601 is configured to determine 1^{st}-stage information, where the 1^{st}-stage information includes information about a resource occupied for decoding 2^{nd}-stage information, and a length of the 1^{st}-stage information is less than or equal to a first length.

The transceiver module 602 is configured to output the 1^{st}-stage information.

Optionally, the transceiver module 602 may include a sending module and a receiving module. The sending module is configured to perform the sending operation in the foregoing method embodiments. The receiving module is configured to perform the receiving operation in the foregoing method embodiments.

It should be noted that the first communication apparatus 600 may include the sending module but not include the receiving module. Alternatively, the first communication apparatus 600 may include the receiving module but not include the sending module. This depends on whether the foregoing solution performed by the first communication apparatus 600 includes a sending action and a receiving action.

Optionally, the first communication apparatus 600 is configured to perform the actions performed by the first communication apparatus in the embodiments shown in FIG. 4 and FIG. 5. For details, refer to the related descriptions in the embodiments shown in FIG. 4 and FIG. 5. Details are not described herein again.

It should be understood that a specific process in which the modules perform the foregoing corresponding process has been described in detail in the foregoing method embodiments. For brevity, details are not described herein again.

The processing module 601 in the foregoing embodiment may be implemented by at least one processor or a processor-related circuit. The transceiver module 602 may be implemented by a transceiver device or a transceiver device-related circuit. The transceiver module 602 may also be referred to as a communication module or a communication interface. The storage module may be implemented by at least one memory.

FIG. 7 is a diagram of a structure of a second communication apparatus according to an embodiment of this disclosure. Refer to FIG. 7. The second communication apparatus 700 may be configured to perform the process performed by the second communication apparatus in the embodiment shown in FIG. 4. For details, refer to the related descriptions in the foregoing method embodiments.

The second communication apparatus 700 includes a processing module 701 and a transceiver module 702.

The processing module 701 is configured to process data. The transceiver module 702 may implement a corresponding communication function. The transceiver module 702 may also be referred to as a communication interface or a communication module.

Optionally, the second communication apparatus 700 may further include a storage module. The storage module may be configured to store instructions and/or data. The processing module 701 may read the instructions and/or the data in the storage module, to enable the second communication apparatus to implement the foregoing method embodiments.

The second communication apparatus 700 may be configured to perform actions performed by the second communication apparatus in the foregoing method embodiments. The second communication apparatus 700 may be a second communication apparatus or a component that may be disposed in a second communication apparatus. The processing module 701 is configured to perform a processing-related operation on a second communication apparatus side in the foregoing method embodiments. The transceiver module 702 is configured to perform a receiving-related operation on the second communication apparatus side in the foregoing method embodiments. For example, the second communication apparatus 700 is configured to perform the following solution.

The transceiver module 702 is configured to receive 1^{st}-stage information and 2^{nd}-stage information that correspond to a same service type, where the 1^{st}-stage information is transmitted on a control channel and/or a shared channel, the 2^{nd}-stage information is transmitted on the shared channel, and the 1^{st}-stage information and the 2^{nd}-stage information are for a same service.

The processing module 701 is configured to: determine a decoding scheme and/or a segmentation scheme of the 2^{nd}-stage information according to a second rule, and decode the 2^{nd}-stage information based on a decoding scheme and/or a segmentation scheme and the 1^{st}-stage information.

Optionally, the transceiver module 702 may include a sending module and a receiving module. The sending module is configured to perform the sending operation in the foregoing method embodiments. The receiving module is configured to perform the receiving operation in the foregoing method embodiments.

It should be noted that the second communication apparatus 700 may include the sending module but not include the receiving module. Alternatively, the second communication apparatus 700 may include the receiving module but not include the sending module. This depends on whether the foregoing solution performed by the second communication apparatus 700 includes a sending action and a receiving action.

Optionally, the second communication apparatus 700 is configured to perform the actions performed by the second communication apparatus in the embodiment shown in FIG. 4. For details, refer to the related descriptions in the embodiment shown in FIG. 4. Details are not described herein again.

It should be understood that a specific process in which the modules perform the foregoing corresponding process has been described in detail in the foregoing method embodiment. For brevity, details are not described herein again.

The processing module 701 in the foregoing embodiment may be implemented by at least one processor or a processor-related circuit. The transceiver module 702 may be implemented by a transceiver device or a transceiver device-related circuit. The transceiver module 702 may also be referred to as a communication module or a communication interface. The storage module may be implemented by at least one memory.

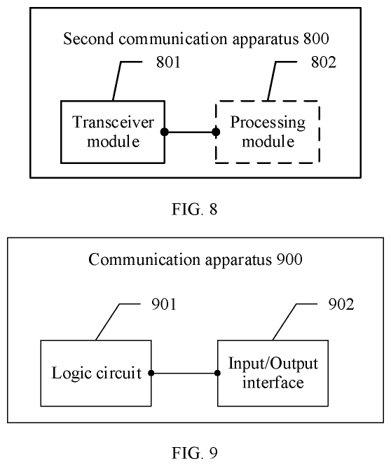

FIG. 8 is a diagram of a structure of a second communication apparatus according to an embodiment of this disclosure. Refer to FIG. 8. The second communication apparatus 800 may be configured to perform the process performed by the second communication apparatus in the embodiment shown in FIG. 5. For details, refer to the related descriptions in the foregoing method embodiments.

The second communication apparatus 800 includes a transceiver module 801.

Optionally, the second communication apparatus 800 further includes a processing module 802.

The processing module 802 is configured to process data. The transceiver module 801 may implement a corresponding communication function. The transceiver module 801 may also be referred to as a communication interface or a communication module.

Optionally, the second communication apparatus 800 may further include a storage module. The storage module may be configured to store instructions and/or data. The processing module 802 may read the instructions and/or the data in the storage module, to enable the second communication apparatus to implement the foregoing method embodiments.

The second communication apparatus 800 may be configured to perform actions performed by the second communication apparatus in the foregoing method embodiments. The second communication apparatus 800 may be a second communication apparatus or a component that may be disposed in a second communication apparatus. The processing module 802 is configured to perform a processing-related operation on a second communication apparatus side in the foregoing method embodiments. The transceiver module 801 is configured to perform a receiving-related operation on the second communication apparatus side in the foregoing method embodiments. For example, the second communication apparatus 800 is configured to perform the following solution.

The transceiver module 801 is configured to receive 1^{st}-stage information, where the 1^{st}-stage information includes information about a resource occupied for decoding 2^{nd}-stage information, and a length of the 1^{st}-stage information is less than or equal to a first length.

Optionally, the transceiver module 801 may include a sending module and a receiving module. The sending module is configured to perform the sending operation in the foregoing method embodiments. The receiving module is configured to perform the receiving operation in the foregoing method embodiments.

It should be noted that the second communication apparatus 800 may include the sending module but not include the receiving module. Alternatively, the second communication apparatus 800 may include the receiving module but not include the sending module. This depends on whether the foregoing solution performed by the second communication apparatus 800 includes a sending action and a receiving action.

Optionally, the second communication apparatus 800 is configured to perform the actions performed by the second communication apparatus in the embodiment shown in FIG. 5. For details, refer to the related descriptions in the embodiment shown in FIG. 5. Details are not described herein again.

It should be understood that a specific process in which the modules perform the foregoing corresponding process has been described in detail in the foregoing method embodiment. For brevity, details are not described herein again.

The processing module 802 in the foregoing embodiment may be implemented by at least one processor or a processor-related circuit. The transceiver module 801 may be implemented by a transceiver device or a transceiver device-related circuit. The transceiver module 801 may also be referred to as a communication module or a communication interface. The storage module may be implemented by at least one memory.

FIG. 9 is a diagram of another structure of a communication apparatus according to an embodiment of this disclosure. Refer to FIG. 9. The communication apparatus 900 includes a logic circuit 901 and an input/output interface 902.

In a possible implementation, the communication apparatus 900 shown in FIG. 9 may be configured to perform the steps performed by the first communication apparatus in the embodiments shown in FIG. 4 and FIG. 5. The logic circuit 901 may have a function of the processing module 601 in the embodiment shown in FIG. 6, and the input/output interface 902 may have a function of the transceiver module 602 in the embodiment shown in FIG. 6.

In another possible implementation, the communication apparatus 900 shown in FIG. 9 may be configured to perform the steps performed by the second communication apparatus in the embodiment shown in FIG. 4. The logic circuit 901 may have a function of the processing module 701 in the embodiment shown in FIG. 7, and the input/output interface 902 may have a function of the transceiver module 702 in the embodiment shown in FIG. 7.

In another possible implementation, the communication apparatus 900 shown in FIG. 9 may be configured to perform the steps performed by the second communication apparatus in the embodiment shown in FIG. 5. The logic circuit 901 may have a function of the processing module 802 in the embodiment shown in FIG. 8, and the input/output interface 902 may have a function of the transceiver module 801 in the embodiment shown in FIG. 8.

The communication apparatus shown in FIG. 9 may perform the technical solutions shown in the foregoing method embodiments. An implementation principle and beneficial effect of the communication apparatus are similar to those of the foregoing method embodiments, and details are not described herein again.

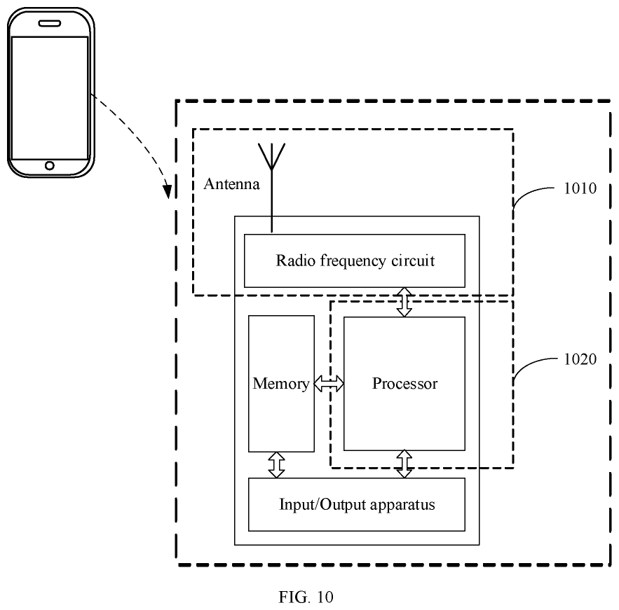

The following shows a diagram of a possible structure of a terminal device with reference to FIG. 10.

FIG. 10 is a diagram of a structure of a terminal device according to an embodiment of this disclosure. For ease of understanding and illustration, in FIG. 10, an example in which the terminal device is a mobile phone is used. As shown in FIG. 10, the terminal device includes a processor, a memory, a radio frequency circuit, an antenna, and an input/output apparatus.

The processor is mainly configured to: process a communication protocol and communication data, control the terminal device, execute a software program, process data of the software program, and the like.

The memory is mainly configured to store the software program and data. The radio frequency circuit is mainly configured to: perform conversion between a baseband signal and a radio frequency signal, and process the radio frequency signal. The antenna is mainly configured to receive/send a radio frequency signal in a form of an electromagnetic wave.

The input/output apparatus, such as a touchscreen, a display, or a keyboard, is mainly configured to: receive data input by a user and output data to the user. It should be noted that some types of terminal devices may have no input/output apparatus.

When needing to send data, after performing baseband processing on the to-be-sent data, the processor outputs a baseband signal to the radio frequency circuit; and the radio frequency circuit performs radio frequency processing on the baseband signal and then sends the radio frequency signal to the outside in a form of an electromagnetic wave through the antenna. When data is sent to the terminal device, the radio frequency circuit receives the radio frequency signal through the antenna, converts the radio frequency signal into a baseband signal, and outputs the baseband signal to the processor. The processor converts the baseband signal into data, and processes the data.

For ease of description, FIG. 10 shows only one memory and one processor. In an actual terminal device product, there may be one or more processors and one or more memories. The memory may also be referred to as a storage medium, a storage device, or the like. The memory may be disposed independent of the processor, or may be integrated with the processor. This is not limited in embodiments of this disclosure.

In this embodiment of this disclosure, the antenna and the radio frequency circuit that have a transceiver function may be considered as a transceiver unit of the terminal device, and the processor that has a processing function may be considered as a processing unit of the terminal device. As shown in FIG. 10, the terminal device includes a transceiver unit 1010 and a processing unit 1020. The transceiver unit may also be referred to as a transceiver device, a transceiver, a transceiver apparatus, or the like. The processing unit may also be referred to as a processor, a processing board, a processing module, a processing apparatus, or the like. Optionally, a component configured to implement a receiving function in the transceiver unit 1010 may be considered as a receiving unit, and a component configured to implement a sending function in the transceiver unit 1010 may be considered as a sending unit. In other words, the transceiver unit 1010 includes the receiving unit and the sending unit. The transceiver unit sometimes may also be referred to as a transceiver, a transceiver device, a transceiver circuit, or the like. The receiving unit sometimes may also be referred to as a receiver, a receiver device, a receive circuit, or the like. The sending unit sometimes may also be referred to as a transmitter, a transmitter device, a transmit circuit, or the like.

It should be understood that the transceiver unit 1010 is configured to perform a sending operation and a receiving operation of the first communication apparatus or the second communication apparatus in the foregoing method embodiments, and the processing unit 1020 is configured to perform operations other than the sending and receiving operations of the first communication apparatus or the second communication apparatus in the foregoing method embodiments.

When the terminal device is a chip, the chip includes a transceiver unit and a processing unit. The transceiver unit may be an input/output circuit or a communications interface, and the processing unit is a processor, a microprocessor, an integrated circuit, or a logic circuit integrated on the chip.

This disclosure further provides a communication apparatus 1100. The communication apparatus 1100 may be a network device or a chip. The communication apparatus 1100 may be configured to perform operations performed by the first communication apparatus or the second communication apparatus in the embodiments shown in FIG. 4 and FIG. 5.

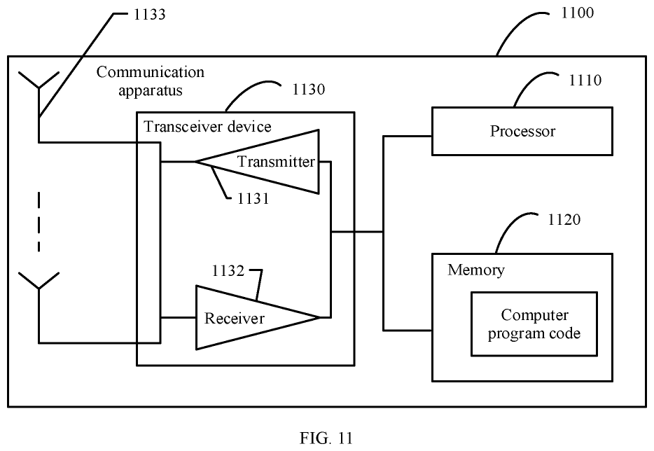

When the communication apparatus 1100 is the access network device, for example, a base station, FIG. 11 is a diagram of a simplified structure of a base station. Refer to FIG. 11. The base station includes a part 1110, a part 1120, and a part 1130.

The part 1110 is mainly configured to: perform baseband processing, control the base station, and the like. The part 1110 is usually a control center of the base station, may usually be referred to as a processor, and is configured to control the base station to perform processing operations on a first communication apparatus side or a second communication apparatus side in the foregoing method embodiments.

The part 1120 is mainly configured to store computer program code and data.

The part 1130 is mainly configured to: receive/send a radio frequency signal and perform conversion between a radio frequency signal and a baseband signal. The part 1130 may be usually referred to as a transceiver module, a transceiver, a transceiver circuit, a transceiver device, or the like. The transceiver module in the part 1130 may also be referred to as a transceiver, a transceiver device, or the like, and includes an antenna 1133 and a radio frequency circuit (not shown). The radio frequency circuit is mainly configured to perform radio frequency processing. Optionally, in the part 1130, a component configured to implement a receiving function may be considered as a receiver, and a component configured to implement a sending function may be considered as a transmitter. In other words, the part 1130 includes a receiver 1132 and a transmitter 1131. The receiver may also be referred to as a receiving module, a receiver device, a receiver circuit, or the like. The transmitter may be referred to as a transmitting module, a transmitter device, a transmitter circuit, or the like.

The part 1110 and the part 1120 may include one or more boards, and each board may include one or more processors and one or more memories. The processor is configured to read and execute a program in the memory, to implement a baseband processing function and control the base station. If there are a plurality of boards, the boards may be interconnected with each other to enhance a processing capability. In an optional implementation, a plurality of boards may share one or more processors, or a plurality of boards share one or more memories, or a plurality of boards share one or more processors at the same time.

For example, in an implementation, the transceiver module in the part 1130 is configured to perform a receiving/sending-related process performed by the first communication apparatus or the second communication apparatus in the embodiments shown in FIG. 4 and FIG. 5. The processor in the part 1110 is configured to perform the processing-related process performed by the first communication apparatus or the second communication apparatus in the embodiment shown in FIG. 4 or FIG. 5.

It should be understood that FIG. 11 is merely an example rather than a limitation, and the network device including the processor, the memory, and the transceiver device may not depend on the structures shown in FIG. 6, FIG. 7, FIG. 8, or FIG. 9.

When the communication apparatus 1100 is the chip, the chip includes a transceiver device, a memory, and a processor. The transceiver may be an input/output circuit or a communication interface. The processor is a processor, a microprocessor, or an integrated circuit integrated on the chip. A sending operation of the first communication apparatus or the second communication apparatus in the foregoing method embodiments may be understood as an output of the chip, and a receiving operation of the first communication apparatus or the second communication apparatus in the foregoing method embodiments may be understood as an input of the chip.

An embodiment of this disclosure further provides a computer-readable storage medium. The computer-readable storage medium stores computer instructions used to implement the method performed by the first communication apparatus or the second communication apparatus in the foregoing method embodiments.

For example, when a computer program is executed by a computer, the computer is enabled to implement the method performed by the first communication apparatus or the second communication apparatus in the foregoing method embodiments.

An embodiment of this disclosure further provides a computer program product including instructions. When the instructions are executed by a computer, the computer is enabled to implement the method performed by the first communication apparatus or the second communication apparatus in the foregoing method embodiments.

An embodiment of this disclosure further provides a communication system. The communication system includes the first communication apparatus in the foregoing embodiments and the second communication apparatus in the foregoing embodiments.

An embodiment of this disclosure further provides a chip apparatus, including a processor, configured to invoke a computer program or computer instructions stored in a memory, so that the processor performs the methods provided in the embodiments shown in FIG. 4 and FIG. 5 above.

In a possible implementation, an input of the chip apparatus corresponds to the receiving operation in embodiments shown in FIG. 4 and FIG. 5, and an output of the chip apparatus corresponds to the sending operation in embodiments shown in FIG. 4 and FIG. 5.

Optionally, the processor is coupled to the memory through an interface.

Optionally, the chip apparatus further includes the memory. The memory stores the computer program or the computer instructions.

Any processor mentioned above may be a general-purpose central processing unit, a microprocessor, an application-specific integrated circuit (ASIC), or one or more integrated circuits configured to control program execution of the methods in the embodiments shown in FIG. 4 and FIG. 5. The memory mentioned anywhere above may be a read-only memory (ROM), another type of static storage device that can store static information and instructions, a random-access memory (RAM), or the like.

It may be clearly understood by a person skilled in the art that for convenient and brief description, for explanations and beneficial effect of related content in any one of the communication apparatuses provided above, refer to the corresponding method embodiments provided above. Details are not described herein again.

In several embodiments provided in this disclosure, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Apart or all of the units may be selected based on actual requirements to achieve the objectives of the solutions of embodiments.

In addition, all functional units in embodiments of this disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions in this disclosure essentially, the part contributing, or all or a part of the technical solutions may be implemented in a form of a software product. The computer software product is stored in a storage medium, and includes several instructions for instructing a computer device (which may be a personal computer, a server, a network device, or the like) to perform all or a part of steps of the method described in embodiments of this disclosure. The foregoing storage medium includes any medium that can store program code, such as a Universal Serial Bus (USB) flash drive, a removable hard disk, a ROM, a RAM, a magnetic disk, or an optical disc.

In conclusion, the foregoing embodiments are merely intended for describing the technical solutions of this disclosure, but not for limiting this disclosure. Although this disclosure is described in detail with reference to the foregoing embodiments, a person of ordinary skill in the art should understand that they may still make modifications to the technical solutions described in the foregoing embodiments or make equivalent replacements to some technical features thereof, without departing from the scope of the technical solutions of embodiments of this disclosure.

1. A method, comprising:
determining 1^{st}-stage information and 2^{nd}-stage information that correspond to a same service type, wherein the 1^{st}-stage information is to be transmitted on a control channel or a shared channel, wherein the 1^{st}-stage information is for decoding the 2^{nd}-stage information, wherein the 2^{nd}-stage information is to be transmitted on the shared channel, and wherein the 2^{nd}-stage information is based on an encoding scheme or a segmentation scheme determined according to a first rule; and
outputting the 1^{st}-stage information and the 2^{nd}-stage information.

2. The method of claim 1, wherein the first rule comprises:
segmenting, based on a first length, the 2^{nd}-stage information to obtain segmented 2^{nd}-stage information; and
encoding, based on a polar code encoding scheme, the segmented 2^{nd}-stage information,
wherein the first length is 2ⁿ, and
wherein n is a positive integer.

3. The method of claim 2, wherein the first length is 32, 64, 128, 256, or 512.

4. The method of claim 1, wherein the first rule comprises:
segmenting, based on a second length, the 2^{nd}-stage information to obtain segmented 2^{nd}-stage information; and
encoding, based on a low-density parity-check code (LDPC) encoding scheme, the segmented 2^{nd}-stage information.

5. The method of claim 4, further comprising determining, based on a payload size and a channel coding rate of the 2^{nd}-stage information, the second length.

6. The method of claim 4, further comprising:
further segmenting, based on the second length of 3840, the 2^{nd}-stage information to obtain first segmented 2^{nd}-stage information, and performing, based on a base graph (BG) 2, LDPC encoding on the first segmented 2^{nd}-stage information when a payload size is less than or equal to 292, or when the payload size is less than or equal to 3824 and a channel coding rate is less than or equal to 0.25; or
further segmenting, based on the second length of 8448, the 2^{nd}-stage information to obtain second segmented 2^{nd}-stage information, and performing, based on a base graph (BG) 1, LDPC encoding on the second segmented 2^{nd}-stage information when the payload size is greater than 292, or when the payload size is greater than 3824 and the channel coding rate is greater than 0.25.

7. The method of claim 1, wherein the first rule comprises determining, based on a payload size of the 2^{nd}-stage information and a channel coding rate of the 2^{nd}-stage information, the encoding scheme or the segmentation scheme.

8. The method of claim 7, wherein the first rule comprises:
encoding, based on a polar code encoding scheme without segmentation, the 2^{nd}-stage information when the payload size is less than or equal to 384 and the channel coding rate is less than or equal to 0.5, or when the payload size is less than or equal to 140; and
further segmenting, based on a segment length of 3840, the 2^{nd}-stage information to obtain segmented 2^{nd}-stage information, and encoding, based on a low-density parity-check code (LDPC) encoding scheme, the segmented 2^{nd}-stage information when the payload size is greater than 384 and the channel coding rate is greater than 0.5, or when the payload size is greater than 140.

9. The method of claim 1, wherein the first rule comprises determining, based on a length of rate-matched 2^{nd}-stage information, a first number of available physical resources, or a modulation order, the encoding scheme or the segmentation scheme.

10. The method of claim 9, wherein the first rule further comprises:
determining, based on a first maximum encoding length supported by a polar code encoding scheme and the first number, a second number of segments of the 2^{nd}-stage information, segmenting, based on the second number, the 2^{nd}-stage information to obtain first segmented 2^{nd}-stage information, and encoding, based on the polar code encoding scheme, the first segmented 2^{nd}-stage information when the length is less than or equal to a maximum length, wherein the maximum length is based on the first number and the modulation order; and
determining, based on a second maximum encoding length supported by a low-density parity-check code (LDPC) encoding scheme and the first number, a third number of segments of the 2^{nd}-stage information, segmenting, based on the third number, the 2^{nd}-stage information to obtain second segmented 2^{nd}-stage information, and encoding, based on the LDPC encoding scheme, the second segmented 2^{nd}-stage information when the length is greater than the maximum length.

11. The method of claim 10, wherein the first number is Eₜₒₜₐₗ, wherein the first maximum encoding length or the second maximum encoding length Nₘ, wherein the second number or the third number is C1 when Eᵣₑₛₜ is less than
$$\frac{9 {N}_{m}}{16} ,$$
wherein the second number or the third number is C1+1 when Eᵣₑₛₜ is greater than or equal to
$$\frac{9 {N}_{m}}{16} ,$$
wherein Eᵣₑₛₜ=Eₜₒₜₐₗ−C₁×Nₘ, and wherein
$${C}_{1} = ⌊ \frac{{E}_{total}}{{N}_{m}} ⌋ .$$

12. The method of claim 1, wherein the first rule comprises:
encoding, based on a polar code encoding scheme without segmentation, the 2^{nd}-stage information when a modulation order of the 2^{nd}-stage information is less than or equal to a first threshold; and
segmenting, based on a third length, the 2^{nd}-stage information to obtain segmented 2^{nd}-stage information, and encoding, based on a low-density parity-check code (LDPC) encoding scheme, the segmented 2^{nd}-stage information when the modulation order is greater than the first threshold.

13. The method of claim 1, wherein the first rule comprises:
encoding, based on a polar code encoding scheme without segmentation, the 2^{nd}-stage information when the 2^{nd}-stage information is first-type information; and
segmenting, based on a fourth length, the 2^{nd}-stage information to obtain segmented 2^{nd}-stage information, and encoding, based on a low-density parity-check code (LDPC) encoding scheme, the segmented 2^{nd}-stage information when the 2^{nd}-stage information is second-type information or third-type information.

14. The method of claim 13, wherein the first-type information is tera-bit multiple-input multiple-output channel state information (T-MIMO CSI), wherein the second-type information is sensing-related information, and wherein the third-type information is artificial intelligence-related information.

15. A method, comprising:
receiving 1^{st}-stage information and 2^{nd}-stage information that correspond to a same service type, wherein the 1^{st}-stage information is from a control channel or a shared channel, and wherein the 2^{nd}-stage information is from the shared channel;
determining, according to a second rule, a decoding scheme or a segmentation scheme of the 2^{nd}-stage information; and
decoding, based on the decoding scheme or based on the segmentation scheme and the 1^{st}-stage information, the 2^{nd}-stage information.

16. The method of claim 15, wherein the second rule comprises:
segmenting, based on a first length, the 2^{nd}-stage information to obtain segmented 2^{nd}-stage information, wherein the first length is 2ⁿ; and
decoding, based on a polar code decoding scheme, the segmented 2^{nd}-stage information.

17. The method of claim 16, wherein the first length is less than 1024.

18. The method of claim 16, wherein the first length is 32, 64, 128, 256, or 512.

19. The method of claim 15, wherein the second rule comprises:
segmenting, based on a second length, the 2^{nd}-stage information to obtain segmented 2^{nd}-stage information; and
decoding, based on a low-density parity-check code (LDPC) decoding scheme, the segmented 2^{nd}-stage information.

20. A communication apparatus, comprising:
a memory configured to store instructions; and
one or more processors coupled to the memory and configured to execute the instructions to cause the communication apparatus to:
determine 1^{st}-stage information and 2^{nd}-stage information that correspond to a same service type, wherein the 1^{st}-stage information is to be transmitted on a control channel or a shared channel, wherein the 1^{st}-stage information is for decoding the 2^{nd}-stage information, wherein the 2^{nd}-stage information is to be transmitted on the shared channel, and wherein the 2^{nd}-stage information is based on an encoding scheme or a segmentation scheme determined according to a first rule; and
output the 1^{st}-stage information and the 2^{nd}-stage information.
